(19) United States
(12) Patent Application Publication
(10) Pub. No.: US 2013/0294707 A1
(43) Pub. Date: Nov. 7, 2013

(54) GEOMETRIC MODELIZATION OF IMAGES AND APPLICATIONS

(71) Applicants: Yosef Yomdin, Rehovot (IL); Dvir Haviv, Rehovot (IL)

(72) Inventors: Yosef Yomdin, Rehovot (IL); Dvir Haviv, Rehovot (IL)

(73) Assignee: YEDA RESEARCH AND DEVELOPMENT LTD, Rehovot (IL)

(21) Appl. No.: 13/807,931

(22) PCT Filed: Jul. 7, 2011
(86) PCT No.: PCT/IB11/53032

§ 371 Date: Jun. 30, 2013

Related U.S. Application Data
(60) Provisional application No. 61/362,338, filed on Jul. 8, 2010.
(60) Provisional application No. 61/392,048, filed on Oct. 12, 2010.

(51) Int. Cl. G06T 9/00

(52) U.S. Cl. CPC G06T 9/008
USPC 382/253

(57) ABSTRACT

A method for processing images includes identifying empiric model elements (EMEs) in an original high resolution photo-realistic image, where each EME includes a straight central segment, a color profile, and a control area; and geometrically modeling the EMEs in vectorized forms to achieve a generally full visual quality for a representation of said image.

### CROSS-REFERENCE TO RELATED APPLICATIONS

This application claims benefit from U.S. Provisional Patent Application No. 61/362,338, filed Jul. 8, 2010, and U.S. Provisional Patent Application No. 61/392,048, filed Oct. 12, 2010, both of which are hereby incorporated in their entirety by reference.

### FIELD OF THE INVENTION

The present invention relates to image vectorization generally and to visual quality for high resolution photo-realistic images in particular.

### BACKGROUND OF THE INVENTION

Model-based representation of images, also known as “vectorization” or “modelization” is known in the art. There are a number of commercially available vectorization packages, such as, Adobe Illustrator, CorelDraw, Inkscape and VectorMagic. VectorMagic also provides an online vectorization service (http://www.wectormagic.com). Such tools are capable of providing high quality vectorized representations (typically in SVG format) of relatively simple images. However, they are generally incapable of capturing fine scale details of high resolution photo-realistic images in vector form.

This issue is well known in the art, and it presents a major obstacle to wide applicability of vectorized formats and processing. It is addressed in various patents and publications, for example, U.S. Pat. Nos. 5,510,838 and 5,960,118. However, while the methods disclosed in these patents and publications do significantly improve resolution of commercial vectorization packages, they do not provide a full visual quality solution for high-resolution images of the real world.

Furthermore, known vectorization methods are typically combined with a certain data reduction or “compression”. A significant drawback of this practice may be that quality degradation is sometimes unpredictable. Accordingly the processing of images in vectorized compressed form may be problematic, since it may lead to uncontrolled visual quality degradation.

### SUMMARY OF THE INVENTION

In accordance with a preferred embodiment of the present invention, there is provided a method for processing images including: identifying empiric model elements (EMEs) in an original high resolution photo-realistic image, where each EME includes a straight central segment, a color profile, and a control area; and geometrically modeling the EMEs in vectorized forms to achieve a generally full visual quality for a representation of the image.

Additionally, in accordance with a preferred embodiment of the present invention, the geometrically modeling includes approximating certain local image patterns with parametric analytic aggregates, where a scale for the geometrically modeling is larger than one pixel in at least one direction.

Further, in accordance with a preferred embodiment of the present invention, the geometrically modeling also includes constructing geometric models as aggregations of the EMEs.

Still further, in accordance with a preferred embodiment of the present invention, the aggregations are chains of EMEs.

Moreover, in accordance with a preferred embodiment of the present invention, the geometric modeling also includes constructing a geometric model from a single isolated EME.

Additionally, in accordance with a preferred embodiment of the present invention, the method also includes: computing an approximating EME at any point and in any direction on the image, where a minimum scale for accuracy is sub-pixel in size.

Further, in accordance with a preferred embodiment of the present invention, the color profile represents image brightness separately for at least each of the colors red, green and blue (RGB) in a scale of a few pixels in a transversal direction to the central segment.

Still further, in accordance with a preferred embodiment of the present invention, the color profile is a spline function of one variable that represents a best approximation of actual image data on the control area.

Moreover, in accordance with a preferred embodiment of the present invention, the method also includes: identifying the color profile directly from data of the image on an image segment of generally a same size and shape that the EME is assumed to represent.

Additionally, in accordance with a preferred embodiment of the present invention, the method also includes imposing the color profile in an image processing process.

Further, in accordance with a preferred embodiment of the present invention, the control area consists of pixels where a color cross-section of the EME determines image color in a generally reliable manner.

Still further, in accordance with a preferred embodiment of the present invention, the color profile for an edge EME consists of a center polynomial of order three and two margin polynomials of order one.

Moreover, in accordance with a preferred embodiment of the present invention, the color profile for a ridge EME consists of one center polynomial and two margin polynomials, all of order two.

Additionally, in accordance with a preferred embodiment of the present invention, the profile for an end EME or an isolated EME is a spline function of two variables defined in its associated control area.

Further, in accordance with a preferred embodiment of the present invention, the computing includes: choosing a profile model depending on a coordinate orthogonal to the central segment, where the profile model is one dimensional; fitting the profile model to the image inside the control area; forming a dense grid G for each edge and ridge element inside the control area within a predetermined distance from the central segment; determining a central polynomial for the color profile as a least square fitting of grey levels on G according to a polynomial of one variable P(yy), where coordinate xx is defined in the edge/ridge direction, with the transversal coordinate yy, and where the polynomial is of degree 3 for the edge elements and degree two for the ridge elements; adding two margin polynomials to the central polynomial to extend the color profile by two pixels, where each margin polynomial adds an additional width of one pixel.

Additionally, in accordance with a preferred embodiment of the present invention, the method also includes: selecting an appropriate method for curvilinear structure detection; employing the appropriate method to produce a collection of directed segments by detecting recognizable curvilinear structures, where each the directed segment generally approximates an associated the curvilinear structure with a sub-pixel accuracy; and performing the computing.

Further, in accordance with a preferred embodiment of the present invention, the method also includes: detecting edge/ridge elements on different scales to provide both higher geometric resolution and robustness.

Still further, in accordance with a preferred embodiment of the present invention, the detecting includes: identifying possible locations of edge/ridge elements in the image, where areas AE approximate an expected location of an identified edge, and areas AR approximate an expected location of an identified ridge; approximating polynomials for grey levels of the image, where for areas AE the polynomial approximation is computed to the third degree, and for areas AR the polynomial approximation is computed to the second degree.

Moreover, in accordance with a preferred embodiment of the present invention, the detecting also includes: applying a least square approximation to results of the approximating polynomials.

Additionally, in accordance with a preferred embodiment of the present invention, the applying is according to a Gaussian weight, where a least square fitting subject to the Gaussian weight effectively provides a fitting for a smaller scale.

Further, in accordance with a preferred embodiment of the present invention, the method also includes calculating a linear polynomial Q(x,y), where the Q(x,y) equals zero; and intersecting straight line defined by Q(x,y) with an area where the computing is performed to provide the central segment.

Still further, in accordance with a preferred embodiment of the present invention, the calculating includes: for an edge, computing a second derivative in the gradient direction for an approximating polynomial P(x,y) of degree 3; and for a ridge, computing eigenvalues and main curvatures and differentiating P in the direction of a larger eigenvalue for an approximating polynomial P(x,y) of degree 2.

Moreover, in accordance with a preferred embodiment of the present invention, the method also includes bundling of segments in the collection according to their geometric proximity; building preliminary chains according to the proximity of the color profiles of the EMEs in the bundles; constructing spline curves to approximate central lines of the preliminary chains; and constructing final chains of EMEs with their associated central segments along the spline curves.

Additionally, in accordance with a preferred embodiment of the present invention, the method also includes: constructing the edge and ridge elements in all relevant colors and different scales to form a set of initially detected EMEs; constructing bundles of the edge and ridge elements according to geometric proximity of the elements; building preliminary chains according to the proximity of the color profiles of the EMEs in the bundles; and constructing the central lines as spline curves approximating the elements of the preliminary chains.

Further, in accordance with a preferred embodiment of the present invention, the constructing bundles is performed separately for the edge and ridge elements.

Still further, in accordance with a preferred embodiment of the present invention, the constructing bundles is performed initially for the edge and ridge elements together and later separated into separate edge and ridge bundles according to a majority of associated elements.

Moreover, in accordance with a preferred embodiment of the present invention, the relevant colors include R, G and B.

Additionally, in accordance with a preferred embodiment of the present invention, the relevant colors include Y, I and Q.

Further, in accordance with a preferred embodiment of the present invention, the all relevant colors are Y in an initial stage of the constructing, where the color profiles are computed for detected shape curves in other color separations to provide an accurate image reconstruction.

Still further, in accordance with a preferred embodiment of the present invention, the method also includes: identifying crossing singularities as center points of dense configurations of the chains of EMEs analyzed in a scale larger than those associated with an EME.

Moreover, in accordance with a preferred embodiment of the present invention, the identifying includes: detecting the dense configurations of chains of EMEs; analytically continuing spline curves of the chains of EMEs up to a distance, where x_i,j represents the intersection points of the continuations; expanding collection x_i,j to include end points of the chains; identifying a preliminary singular point “x” as a central point of (x_i,j); and adding artificial segments to join the preliminary singular point “x” with the end points.

Further, in accordance with a preferred embodiment of the present invention, the method also includes identifying the preliminary singular points as curvature singularities when just two chains come together, where an angle between the continuations is greater than a pre-determined threshold.

Additionally, in accordance with a preferred embodiment of the present invention, the method also includes: analyzing points on the EME chains where color profiles have abrupt changes to identify the preliminary singular points as color singularities, where the abrupt changes exceed a pre-determined threshold.

Further, in accordance with a preferred embodiment of the present invention, the method also includes: computing at least the EMEs and their color profiles along the artificial segments; identifying a normal form according to a geometric structure of the preliminary singular point “x” and the structure of EMEs in a vicinity of “x”; transforming the preliminary singular point “x” to its the normal form; iterating the computing, the identifying and the transforming a pre-determined number of times; and defining the preliminary singular point “x” as a singular point according to attributes determined during the iterating.

Still further, in accordance with a preferred embodiment of the present invention, the identifying includes identifying the normal form from a list of the normal forms, where the list is constructed empirically, according to requirements of a specific application.

Moreover, in accordance with a preferred embodiment of the present invention, the identifying the normal form also includes performing normalizing transformations on the singular point “x” to yield the normal form.

Additionally, in accordance with a preferred embodiment of the present invention, the method also includes: aggregating the chains of edge and ridge elements into connected graphs G_j, where the singular points are vertices of graph G and the element chains are edges of the graph G, where the graphs G_j are sub-graphs of connected components of G, such that the vertices of G_j are denoted as V_ji and the edges of G_j are denoted as E_ji; and defining a skeleton “S” as a union of all the graphs G_j with l(G_j)>“ds”, where “ds” is a pre-determined threshold of pixels.

Further, in accordance with a preferred embodiment of the present invention, the method also includes defining a model texture “MT” as a union of all the graphs G_j not included in the skeleton “S”.

Still further, in accordance with a preferred embodiment of the present invention, the method also includes capturing model texture by applying wavelets to a complement of the skeleton “S”.

Moreover, in accordance with a preferred embodiment of the present invention, a value for “ds” is between 3 and 16 pixels.

Additionally, in accordance with a preferred embodiment of the present invention, the method also includes: ordering graphs G_j according to decreasing length; filtering the EMEs of all the G_j according to descending order of maximal length to eliminate redundant EMEs; constructing new the chains, singularities and graphs G_j from remaining EMEs; and iterating the ordering, filtering and constructing without including previous graph G_s until all the redundant EMEs are eliminated.

Further, in accordance with a preferred embodiment of the present invention, the method also includes: for each pixel in model control area “MCA”, expanding a signal until it stops, thus covering a connected component in the image, where the expanding stops over SCA, and where skeleton control area “SCA” is defined as a union of all the control areas of the EMEs in the skeleton, texture control area “TCA” is defined as a union of all the control areas of the EMEs in the model texture, model control area “MCA” is defined as a union of TCA and SCA, and background area “BA” is defined as all the pixels in the image not in MCA; covering the connected components by bounding rectangles; and constructing a polynomial approximation of color data for the image for each the rectangle to approximate a background for the image.

Still further, in accordance with a preferred embodiment of the present invention, the method also includes reconstructing the background by reversing processing of the constructing, the covering and the expanding.

Moreover, in accordance with a preferred embodiment of the present invention, the method also includes enabling image instruction in a form of high-level geometric modeling language (HLGML) by applying image processing operations directly on modelized images.

Additionally, in accordance with a preferred embodiment of the present invention, the processing operations include at least one of performing interactive skeleton deformations;

morphing texture; modifying geometric characteristics of at least one of the elements in accordance with stated thresholds; and interactively controlling cross-section properties.

Further, in accordance with a preferred embodiment of the present invention, the performing interactive skeleton deformations includes: enabling interactive prescription of a morphing operation; applying a standard mathematical extension F of the prescribed morphing to an entire the image; applying the F to each geometric parameter of the skeleton in turn, where the parameters comprise at least the chains of elements, the singularities, and widths of the color profiles; and preserving brightness parameters of the color profiles.

Still further, in accordance with a preferred embodiment of the present invention, the morphing texture includes: enabling interactive prescription of a morphing operation; applying a standard mathematical extension F of the prescribed morphing to an entire the image; applying the F to each geometric parameter of the texture in turn, where the parameters comprise at least the chains of elements, the singularities, and widths of the color profiles; preserving brightness parameters of the color profiles; and returning the texture models to their original background domains.

Moreover, in accordance with a preferred embodiment of the present invention, the method also includes enabling automatic-interactive relative depth identification.

Additionally, in accordance with a preferred embodiment of the present invention, the enabling includes: analyzing the edges and ridges of the skeleton according to type of the singularities in the edges and ridges to identify occlusion patterns on the skeleton; attempting to define occluded layers and order them according to relative depth via an automatic process; when the attempting is unsuccessful, indicating the edges identified as problematic by the automatic process to a user; receiving input from the user regarding the problematic edges, where the input is at least one of a relative depth, occlusion pattern, continuation and completion of a the problematic edge.

Further, in accordance with a preferred embodiment of the present invention, the color profile also represents information for a “depth” color.

Still further, in accordance with a preferred embodiment of the present invention, the depth information is obtained in at least one of the following ways: 3D sensing, provided as part of a general description of the image and synthetic insertion.

Moreover, in accordance with a preferred embodiment of the present invention, the method also includes: performing automatic-interactive relative depth identification to provide relative depth of different layers; and employing “shape from shading” methods to approximate true depth for the geometric models on the image.

Additionally, in accordance with a preferred embodiment of the present invention, the method also includes: analytically continuing spline curves representing the central lines of the EME chains in image skeleton S into an occluded area up to a distance “d”, where “d” expresses a desired depth for completion of the occluded area; for intersecting the continued spline curves, if the angle between the continued spline curves exceeds 90 degrees, stopping the continuing, and otherwise continuing in a bissectrice direction up to the depth d; extending the models texture MT and the background according to a background partition by the skeleton by creating strips around a boundary between regular and occluded pixels, where a width of these strips is a given parameter, and the strips are created separately in each domain of a complement to the extended skeleton; dividing each strip into two sub-strips, where a first the sub-strip is located in a domain of regular (non-occluded) pixels, and a second the sub-strip is located in a domain of the occluded pixels; and completing the texture objects by randomly copying blocks of pixels from the first sub-strip to the second sub-strip.

Further, in accordance with a preferred embodiment of the present invention, the method also includes completing regions of the originally occluded area by painting their pixels according to the color of neighboring pixels.

Still further, in accordance with a preferred embodiment of the present invention, the method also includes: enabling a user to interactively mark the spline curves for the continuing.

Moreover, in accordance with a preferred embodiment of the present invention, a total data volume for the representation is less than that of the image.

Additionally, in accordance with a preferred embodiment of the present invention, the method also includes detecting edge and ridge elements; and automatically fitting models in an image animation application as per the detected edge and ridge elements.

Further, in accordance with a preferred embodiment of the present invention, the method also includes reconstructing the occlusions to complete an image completion in a context of an image animation application.

Still further, in accordance with a preferred embodiment of the present invention, the reconstructing is one of automatic and automatic-interactive.

In accordance with a preferred embodiment of the present invention, there is also provided an image compression method implemented on a computing device, the method including: geometrically modelizing an image; filtering each model created in the modelizing with quality control as per an allowed reconstruction error A_0; for each singular point, saving type of normal form (NF) in list LNF together with parameters of normalizing transformation NT; saving chains of graphs G_j according to combinatorial type, vertices coordinates and parameters of spline curves representing each EME's chains, joining said vertices;

approximating parameters of color profiles of the EMEs along said chains with a prescribed accuracy A_1; quantizing geometric parameters of the models up to accuracy A_2; aggregating each of the parameters of the models according to their expected correlations; and organizing the aggregated parameters according to type in files.

Additionally, in accordance with a preferred embodiment of the present invention, the method also includes further compressing said files with statistical compression.

Further, in accordance with a preferred embodiment of the present invention, a value for A_0 is one half of a grey level; a value for A_1 is one half of a grey level; a value for A_2 is one tenth of a pixel; and a value for A_3 is one half of a grey level.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIGS. 1-4, 6, 8-10, 12, 13, 15-17, and 19-25 are illustrations and diagrams useful in the understanding and presentation of the present invention; and

FIGS. 5, 7, 11, 14, 18 and 26 are block diagrams of processes constructed and operative in accordance with a preferred embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Applicants have realized that using “preliminary geometric models” called “Empiric Model Elements” (EME) in vectorized forms to increase the efficiency of processing images may facilitate the achieving of a full visual quality for high resolution photo-realistic images. An image representation scheme based on such “geometric models”, may satisfy the following two requirements: the representation may preserve a full visual quality of high resolution photo-realistic images; and the total data volume in the representation may be significantly lower than in the original pixel image.

Geometric models may be parametric analytic aggregates approximating certain local image patterns. They may be assumed to represent a local visual content of an image. Accordingly, one pixel may not be considered a geometric model, since, by itself; a single pixel on the image does not represent any meaningful visual content. Consequently, it may be understood that the scale of geometric models must be significantly larger than one pixel, at least in one certain direction.

It will be appreciated that the description below may use specific thresholds measured in “pixels”. In accordance with a preferred exemplary embodiment of the present invention, the images discussed hereinbelow may generally have an approximate size 500×700 pixels. They may be presented on a high quality computer screen with a resolution of approximately 800×1200 pixels, which may be assumed to be viewed by an average operator from a distance of approximately 50 cm. All references to “visual quality”, “visually significant patterns of the images”, etc. may be assumed to be based on such an embodiment. It will be appreciated that these assumptions may represent just one exemplary embodiment; the thresholds may be rescaled as necessary in accordance with other circumstances.

In accordance with a preferred embodiment of the present invention, EMEs may be defined as the basic finest scale “preliminary geometric models”. Geometric models may be constructed as aggregations (typically, chains) of EME's. It will, however, be appreciated, that as will be discussed hereinbelow, some EME types may also appear as final models.

The following characteristics may characterize prior art edge and ridge elements: as the names imply, edge and ridge elements may typically have been constructed at, and/or in association with, edges and ridges. The color profiles of edges and ridges may typically have a priory chosen shape, the profiles for which having been computed from the filtering data used in edge (ridge) detection. Accordingly, the definition of the edge and ridge elements in the prior art may have had an inherent inconsistency: while the element may typically have been constructed to cover an area of a width of around one pixel in the edge (ridge) direction, and of a width of 3-5 pixels in the transversal direction, the profiles may have been computed on an entire cell, typically 5×5 pixels. This practice may dramatically reduce the accuracy of the color profile in complex images and cause significant visual quality problems.

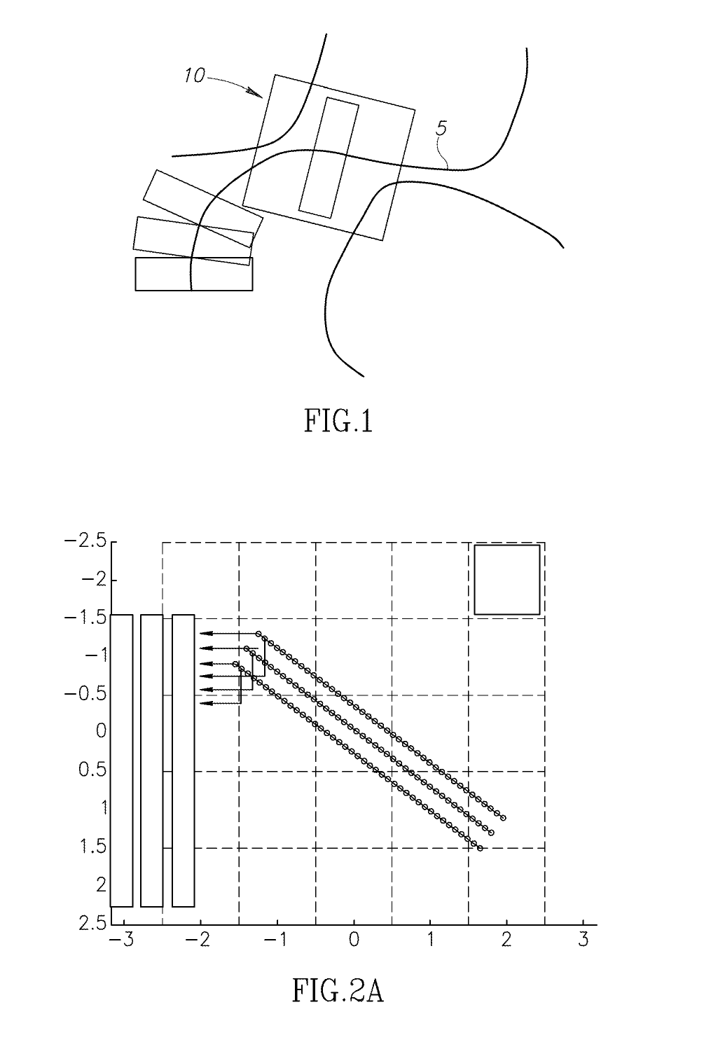

Reference is now made to FIG. 1 which illustrates a small segment of an image. A ribbon-like edge 5 may be clearly discernible in the image. However, when computing a color profile for the detected ridge as per the prior art methods described hereinabove, it will be appreciated that the entire contents of cell 10 may be processed.

Another significant problem with prior art methods is that edge and ridge elements may be defined only if and when an edge (or ridge) may be detected. However, many visually important curvilinear structures on images may be neither edges nor ridges. This may be observed frequently in fine scale “transition areas” between edges and ridges.

In accordance with a preferred embodiment of the present invention, using EMEs may address and resolve both of these issues. First, an “approximating” EME may be computed at any point and in any direction on an image, even with a sub-pixel accuracy. As may be expected, EMEs may tend to be identified along visually important curvilinear structures on images, however, these structures may not be explicit edges or ridges. Secondly, a color profile may be identified directly from the image data on an image segment of roughly the same size and shape that the EME may be assumed to represent.

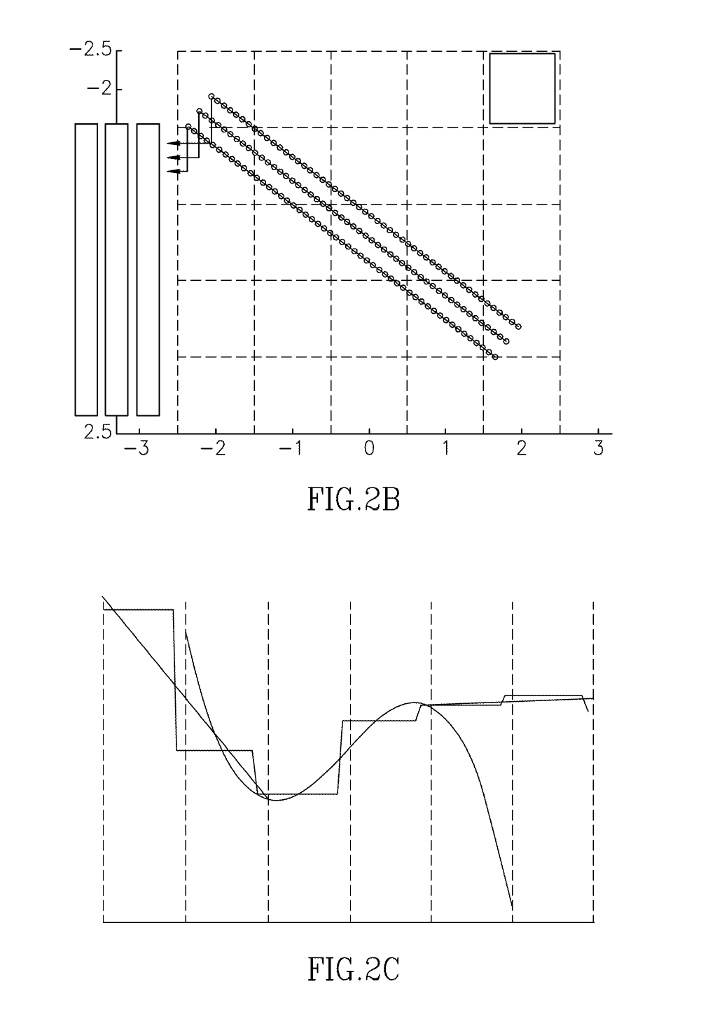

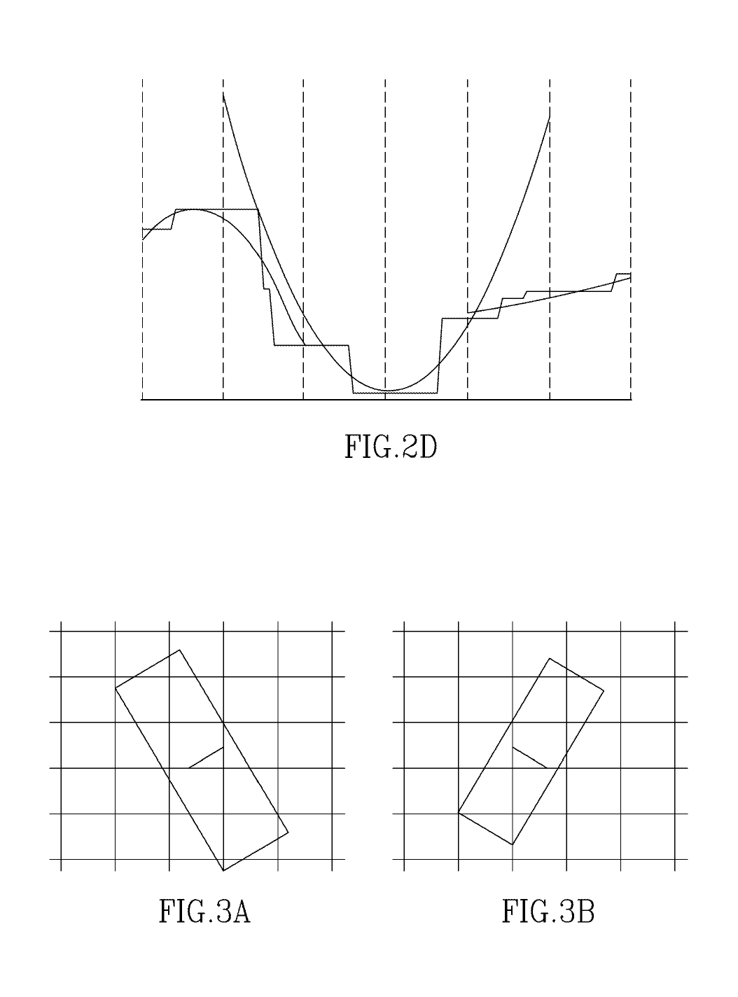

EMEs may comprise a straight central segment, a color profile and a control area. The straight central segment may capture the position and direction of a visual pattern on an image with a sub-pixel accuracy. Reference is now made to FIGS. 2A and 2B. The “color profile” may represent the image brightness (in each of the colors R, G, and B separately) in a scale of a few pixels in a transversal direction to the central segment. The color profile may be a spline function of one variable. It may be determined as a best approximation of the actual image data on the control area of the element, as described below. Alternatively, the color profile of a given element may be imposed in the process of image processing. FIGS. 2C and 2D, to which reference is now made, illustrate exemplary color profiles.

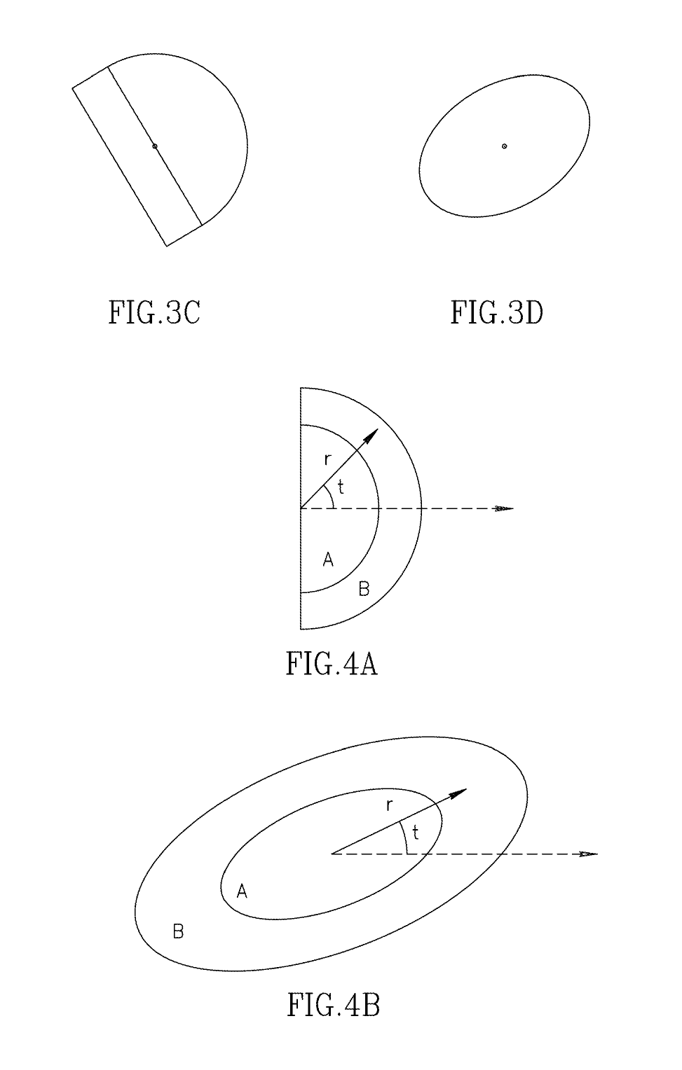

The “control area” of an element may consist of the pixels where the element's color cross-section determines the image color in a reliable way. An exemplary control area of an edge element is shown in FIG. 3A, to which reference is now made. An exemplary control area for a ridge element may be illustrated in FIG. 3B, to which reference is now also made.

There may be two special types of EME's: the “End EME” and the “Isolated EME”. End EMEs may typically appear at the ends of the chains; isolated EMEs may form an entire chain by themselves. These special elements may have different control areas and color profiles. FIGS. 3C and 3D may illustrate exemplary control areas for an End EME and an Isolated EME respectively.

It will be appreciated that while the width of a control area in an orthogonal direction to an element may typically be 6 pixels for edges and 4 pixels for ridges, the width in the element direction may typically be around one pixel. It will further be appreciated that there may be exceptions. For example, as shown in FIGS. 3C and 3D, the control area of an “end element” may resemble the control area of a typical element, with an additional half-circle added on one side. The control area of an “isolated element” may typically resemble an ellipse with semi-axes of between 1 to 3 pixels.

Returning now to FIGS. 2A and 2B, each of these figures may illustrate color profiles for edge ridge elements. In accordance with a preferred embodiment of the present invention, the color profile of an edge element may consist of three polynomials: a center polynomial of order three, and two margin polynomials of order one. The color profile of a ridge element may consist of three polynomials: one center polynomial and two margin polynomials, all of which may be of order two.

The color profile of an end element or of an isolated element may be a spline function of two variables defined in its control area. It may be determined as a best approximation of the actual image data on the control area of the element, as described hereinbelow. Alternatively, the color profile of a given element may be imposed in the process of image processing and alteration.

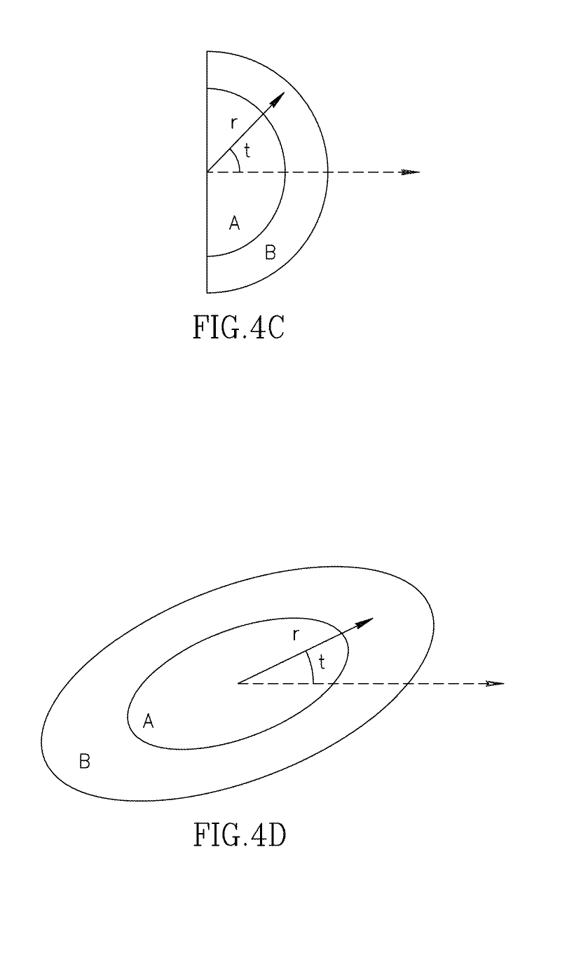

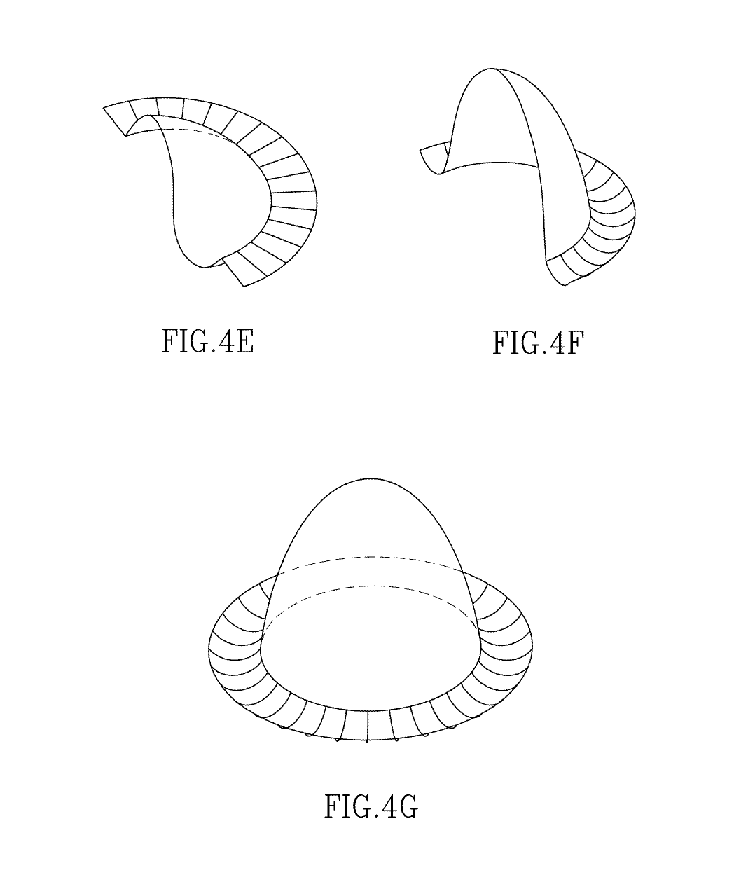

Reference is now made to FIG. 4A which illustrates the color profile of an “end element”. In the example illustrated, the color profile of an “edge end element” may consist of a third degree polynomial P(x,y) over interior part A of the control area as shown in FIG. 4C, and of the polynomial Q(r,t) of the form Q(r,t)=(a_0+a_1t)r+(b_0+b_1t) on the exterior part B of the control area. r and t may be the polar coordinates as shown on FIG. 4A. The color profile of a “ridge end element” may consist of a second degree polynomial P(x,y) over the interior part A of the control area as shown in FIG. 4C, and of the polynomial Q(r,t) of the form Q(r,t)=(a_0+a_1t)r̂2+(b_0+b_1t)r+(c_0+c_1t) on the exterior part B of the control area. As with the previous representation of an edge end element, r and t may be the polar coordinates as shown on FIG. 4C.

Reference is now made to FIG. 4B which illustrates the color profile of an isolated element. In the example illustrated, the color profile of an “isolated element” may consist of a second degree polynomial P(x,y) over the elliptic interior part A of the control area shown in FIG. 4D, and of the polynomial Q(r,t) of the form Q(r,t)=(a_0+a_1t)r̂2+(b_0+b_1t)r+(c_0+c_1t) on the exterior part B of the control area. r and t may be the “elliptic polar coordinates” as shown in FIG. 4D.

It will be appreciated that the profile polynomials as above may typically be determined by a least square approximation on the corresponding areas, as may be explained in detail hereinbelow. FIGS. 4E-4G, to which reference is now made, may show the general shape of the color profiles of the end and isolated elements.

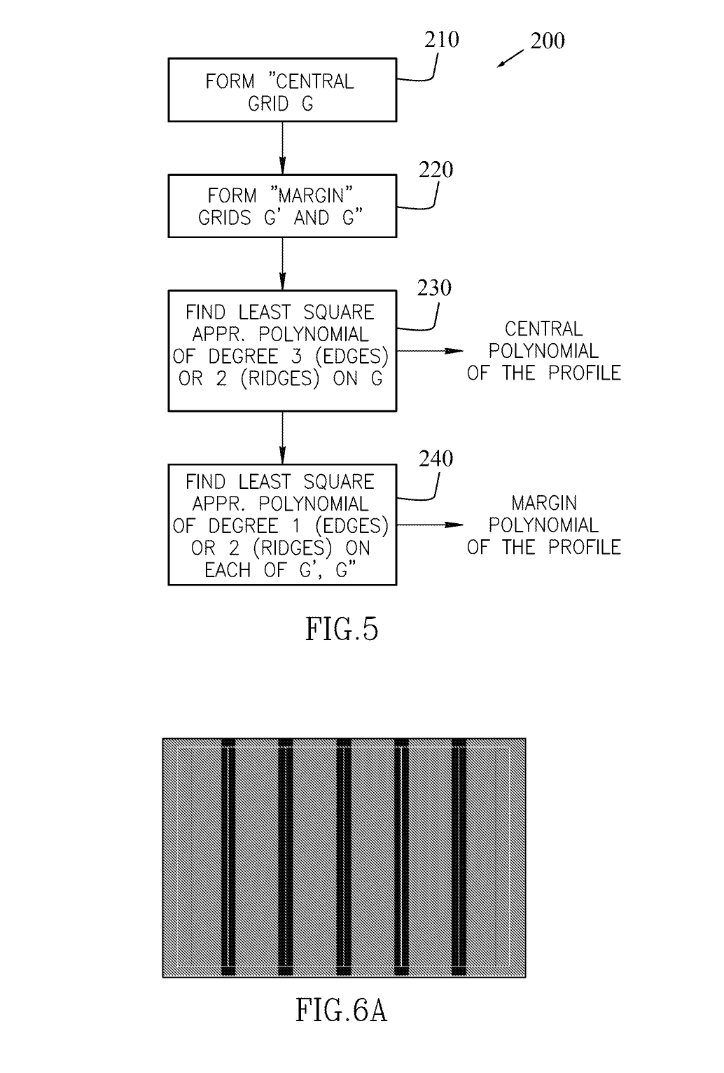

Reference is now made to FIG. 5 which illustrates a novel approximating EME construction process 200, to be performed by an approximating EME constructor unit, constructed and operative in accordance with a preferred embodiment of the present invention. The construction of an approximating EME (for edges and ridges) may begin with a given central segment of the EME. Next, the chosen profile model, which may depend only on the coordinate orthogonal to the central segment, may be fitted to the image, inside the control area. Being essentially one-dimensional, such a model may have fewer degrees of freedom than a general third (second) degree polynomial in two variables. Consequently, its robust identification may be possible on a smaller control area, i.e. in a finer scale.

In more detail, as illustrated in FIG. 2A, a dense grid G may be formed (step 220) for edge and ridge elements inside the element's control area, up to a distance 2 pixels from the central segment for edges and ridges on 5×5 cells, and 1 pixel from the central segment for ridges on 3×3 cells.

The grey level at each point of G may be the value at the pixel to which the point may belong. Coordinate xx may be defined in the edge direction, with the transversal coordinate yy. A polynomial of one variable P(yy) (of degree 3 for edge, and of degree 2 for ridge) may provide (step 230) a least square fitting of the grey levels on G. This may be the central polynomial in the color profile. It will be appreciated that P(yy) may provide a significantly better approximation of the true image values inside the control area than the original polynomial since the fitting may be performed only on the contents of this control area. Even so, the fitting operation may still be sufficiently robust, as P(yy) may only have 4 for edges (3 for ridges) coefficients to be determined.

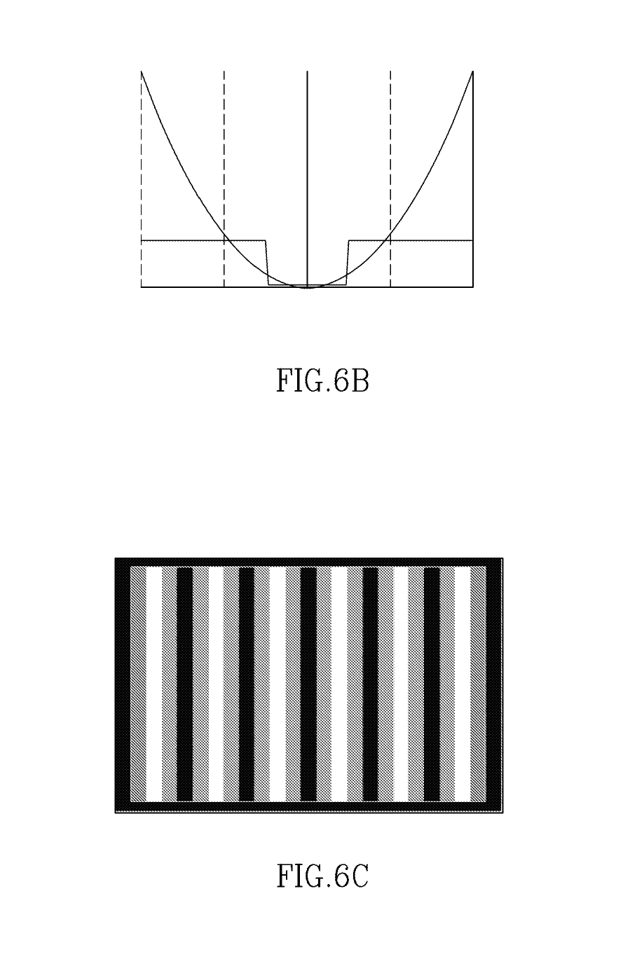

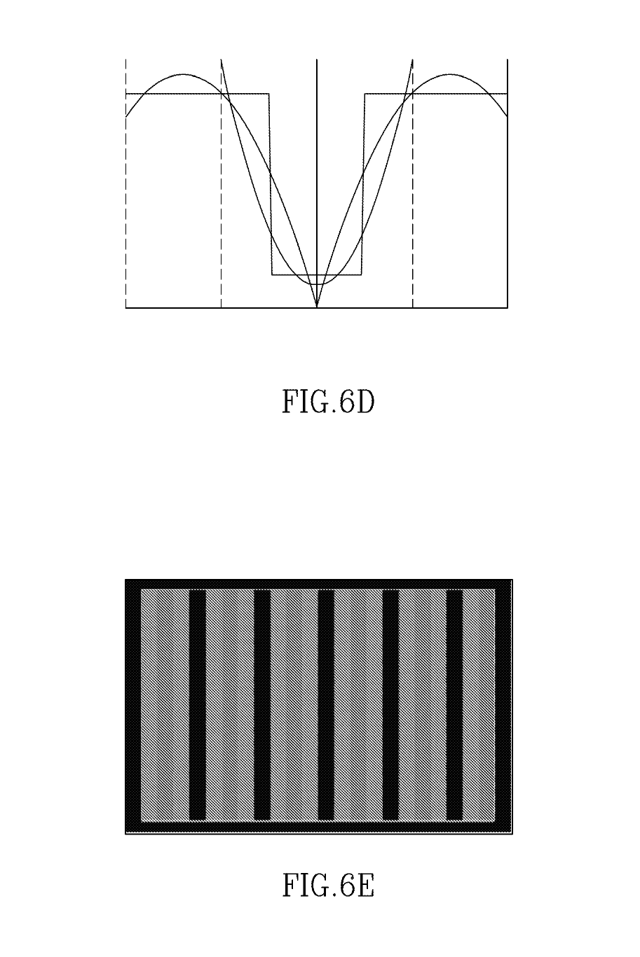

The width of the color profile may be extended (step 240) by 2 pixels, adding two margin polynomials to the central polynomial, each covering the additional width of one pixel. They may be constructed in essentially the same manner as the central polynomial, but using the margin grids G′ and G″ instead, as illustrated in FIG. 6, to which reference is now made.

FIGS. 6A-E together may illustrate the results of the construction described hereinabove. FIG. 6A may show an original image. FIG. 6B may show the ridge profile without margin polynomials. FIG. 6C may show the resulted distortion in the reconstruction—white strips between the dark ridges. FIG. 6D may show a representation of the extended color profiles of the original image. FIG. 6E may show the reconstruction result.

It will be appreciated that there may be some disagreement between the reconstructed and original images in the areas between the ridges. In fact, a proper tuning of the ridge detection thresholds in the algorithm may produce ridges also at these middle columns, which may provide a generally completely accurate reconstruction.

The profiles of the end and isolated approximating EME's may be constructed using generally the same method.

In accordance with a preferred embodiment of the present invention, the modelization process for a given image may start with the initial identification of the image's “active EMEs”. As will be discussed hereinbelow, some other EMEs may be added or omitted later. However, the typical process may begin with identification of active EMEs.

As noted hereinabove, an approximating EME may be constructed at any point of an image and for any direction at this point (in mathematical coordinates on the image, not only at the pixel points). However, geometric models, which as described hereinabove may be comprised of certain chains of EMEs, may be assumed to represent visually appreciable curvilinear patterns on the image. Accordingly, appropriate curvilinear structures may be defined and used as necessary for each specific application. Typically, these may be edges and ridges. A preferred method for their detection may be disclosed hereinbelow. It will, in any case, be appreciated that for some applications other curvilinear structures may be appropriate. Accordingly, for some applications the gradient and curvature lines of image brightness, the “talweg lines” for various height functions, and/or other may be used.

Accordingly, the first step of the modelization process may be to detect curvilinear structures of a prescribed type. Any suitable method, as known in the art, may be used. Preferably, the method should provide a collection of directed segments as its output, with each segment approximating the curvilinear structure in question with a sub-pixel geometric accuracy. Any of the many known methods for sub-pixel geometric accuracy edge and ridge detection may provide the preferred functionality.

It will be appreciated that the requirement to produce a collection of directed segments may be preferred but not essential for the implementation of the present invention. Even if the selected method produces as its output just collections of pixels, directed segments may be relatively easily reconstructed by any suitable appropriate approximation procedure known in the art. Accordingly, for a given specific image processing task, the best known method for the detection of the relevant curvilinear structures may be employed, even if it just produces collections of pixels as output.

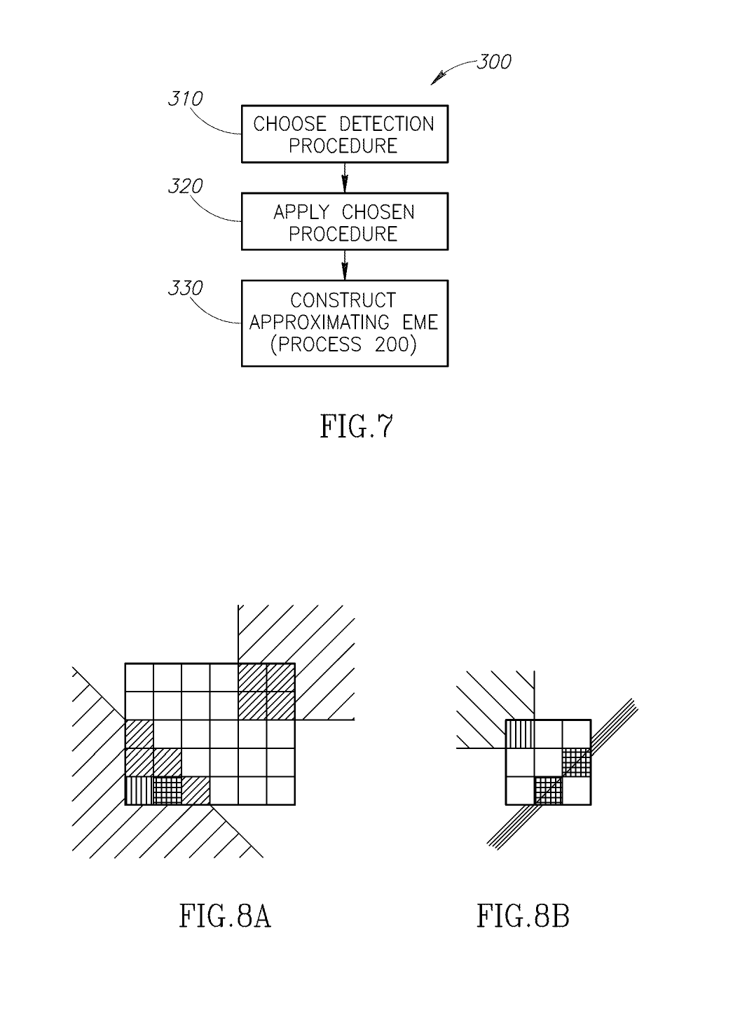

Reference is now made to FIG. 7. In accordance with a preferred embodiment of the present invention, a novel initial identification process 300 for a given image's “active EME's” may be performed in the following steps:

A suitable procedure may be chosen (step 310) for detection of curvilinear structures of a prescribed type, as per the requirements of the particular application.

The chosen procedure may be applied (step 320) to the processed image. In accordance with an exemplary embodiment of the present invention it may be assumed that the procedure's output may be a collection Z of directed segments, approximating the curvilinear structure in question with a sub-pixel geometric accuracy. As discussed hereinabove, if the output of the chosen procedure may be collection of pixels (or any other form known in the art), a known suitable procedure to approximate this output with a collection Z of directed segments may first be applied, approximating the curvilinear structure in question.

At each directed segment process 200 as disclosed hereinabove may be applied (step 330) to this segment as a central segment.

In accordance with a preferred embodiment of the present invention, a novel edge and ridge detection method may be employed to provide higher resolution and geometric accuracy than the prior art. As discussed hereinabove, there may be a significant quality problem when using the existing approaches. It may be caused by an insufficient geometric resolution of the ridges and edges detection, even in their “sub-pixel accuracy” form. It will be appreciated that this is may not be a trivial issue; for a geometrically accurate detection of edges, a filter mathematically equivalent to the third degree polynomial approximation may be required.

Applicants note that it is known empirically that the minimal cell-size necessary for a robust third order analysis (in particular, with respect to a noise that we can expect even in the high quality images) may be 5×5 pixels. For ridges (with second order analysis) this minimal scale may be roughly 3×3 pixels. Accordingly it will be appreciated that reconstructing 10 coefficients of a polynomial P(x,y) of degree 3 from 16 grey level values of pixels in a 4×4 pixels cell may be quite difficult in the presence of realistic noise. Accordingly, in the same way that 9 grey level values of pixels in a 3×3 pixels cell may be a minimum necessary for a robust reconstruction of 6 coefficients of an approximating polynomial P(x,y) of degree 2, so too in most approaches for sub-pixel accuracy edge and ridge detection the minimal scale of edge detection may be set to 5×5 pixels (3×3 pixels for ridge detection).

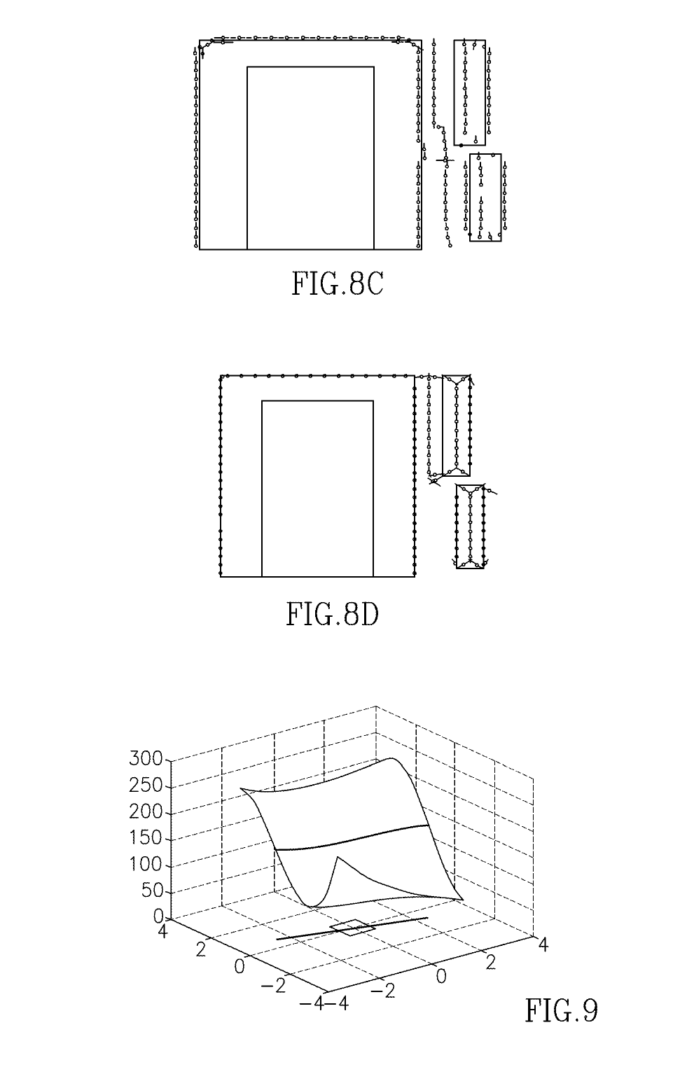

Even so, in dense image areas a 5×5 pixels cell (and even a 3×3 pixels cell) may easily contain multiple instances of edges and/or ridges. FIGS. 8A and 8B, to which reference is now made, illustrate two such examples. In these cases the result of the third (second) order edge (ridge) detection may become completely unreliable; none of the multiple edges (ridges) may be captured.

Accordingly there may be a conflict between contradicting requirements for higher geometric resolution (smaller analysis cell) and robustness (larger cell). Reference is now made to FIGS. 8C and 8D. FIG. 8C represents a detection result on 5×5 pixel cells with uniform weight, while FIG. 8D may represent the effect of a Gaussian weight applied to the center.

In accordance with a preferred embodiment of the present invention, a multi scale approach may be used to resolve the conflict. Exemplary scales may include 11×11, 5×5 and 4×4 pixels cells, as well as Gaussian weights, for edge detection; and 5×5 and 3×3 pixels cells, as well as Gaussian weights may be used in ridge detection. In order to simplify the process, only the finest scale—where resolution problems may most typically appear—may be discussed explicitly. It will be appreciated however that the present invention may also include less fine scales.

In order to satisfy the apparently self-contradictory requirement of increasing geometric resolution while preserving high robustness of the analysis, this analysis may be performed in three stages:

Known methods of maximizing an image response to a bank of filters may be used to identify possible locations of edge (ridge) elements. Image areas AE and AR may accurately approximate the expected locations of edges and ridges, respectively.

The next stage may be to approximate third degree polynomials for the image's grey levels. For area AE the third degree polynomial approximation of the image grey level on all the 4×4 pixels cells may be computed. For area AR the second degree polynomial approximation of the image grey level on all the 3×3 pixels cells may be computed.

In accordance with an optional embodiment of the present invention, a least square approximation may be applied with the uniform weight, or alternatively with a Gaussian weight function, which may stress the influence of the central pixels. The next stage may be to apply a Gaussian weight function to the previous results. A least square fitting subject to a Gaussian weight function, sharply concentrated at the center of the 3×3 pixels cell, may be informally interpreted as a fitting on 2.5×2.5-cell (which may generally not be directly feasible) Accordingly, for this computation cells smaller than 3×3 may be appropriate, for example, 2.5×2.5.

It will be appreciated that the 4×4 pixels filter may provide more natural sub-pixel accuracy edge detection than that of 5×5 pixels. In fact, its center may be between the pixels, in accordance with a typical position of high resolution edges. FIGS. 8C and D may show the results of edge and ridge detection, once more, with and without the addition of Gaussian weights.

It will be appreciated that the results of the polynomial approximation as disclosed hereinabove may be relatively robust, because the processing may have been restricted to “Edge Area” AE and/or “Ridge Area” AR. This may be explained by the brightness shape of the image in the area AE resembling a shape of a typical edge. So in practice the approximating polynomial P(x,y) may not materially depend on a coordinate xx in the edge directionll, but instead may be almost totally dependent on the transversal coordinate yy.

Accordingly, P(x,y) approximates to a polynomial of one variable PP(yy). But a polynomial PP(yy) of degree 3 may have only 4 coefficients, so its calculation from 16 grey level values of pixels in a 4×4 pixels cell may be much more robust than of a general degree 3 polynomial of two variables. Similarly, the brightness shape of the image in the area AR may resemble a shape of a typical ridge. Accordingly, in practice the approximating polynomial P(x,y) may not materially depend on a coordinate xx in the ridge direction, but instead may be almost totally dependent on the transversal coordinate yy. Accordingly, P(x,y) may approximate to a polynomial of one variable PP(yy). But a polynomial PP(yy) of degree 2 has only 3 coefficients, so its calculation from approximately 6 grey level values of pixels in a 2.5×2.5 pixels cell may be much more robust than of a general degree 2 polynomial of two variables. This explanation may remain valid even though the usual two-dimensional polynomials may have been used during the first step and not the rotated one-dimensional polynomials. Even so, the approximation results in the image areas AE and AR may be reasonably stable, in contrast to other image regions. The reason may be that under the a priori information on the image structure in the areas AE and AR, the probability that random noise in the pixels cancels out in a computation of the approximating polynomial, is much higher than in general.

After the approximating polynomials have been constructed as described hereinabove, the central segments of edge and ridge elements may be calculated in the final stage.

Reference is now made to FIG. 9. The required procedure may generally use the “zero crossing” approach as known in the art. For an approximating polynomial P(x,y) of degree 3 (edge detection) its second derivative in the gradient direction may be computed. This may be a linear polynomial Q(x,y) which may be equated to zero. The straight line Q(x,y)=0 may be intersected with the area of the pixel where the computation may be performed. The result may be the central segment of the edge element to be constructed.

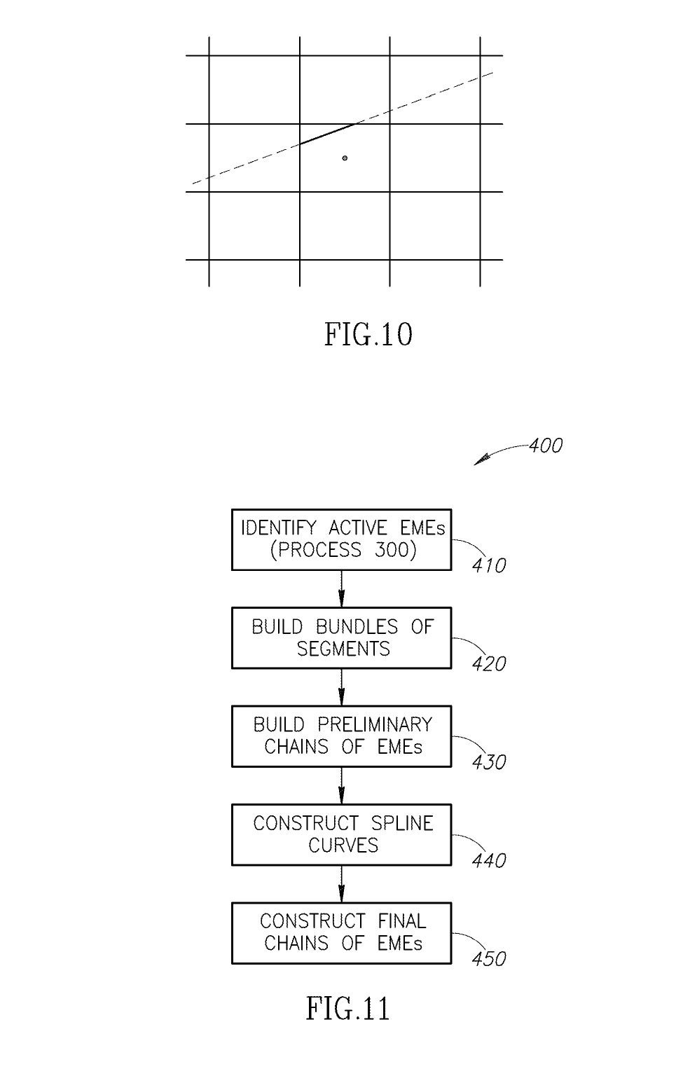

It will be appreciated that any elements “far away from the pixel center” (i.e. those not crossing the pixel area) may be ignored as unreliable. Reference is now made to FIG. 10 which may illustrate an exemplary central segment reconstruction. For an approximating polynomial P(x,y) of degree 2 (ridge detection) the eigenvalues and the corresponding directions of the quadratic part of P (“main curvatures”) may be computed, and P differentiated in the direction of the larger eigenvalue. The resulting linear polynomial Q may be equated to zero, and the rest may be performed as described for edges processing hereinabove.

Empiric model elements, as defined within the context of the present invention, may be organized in chains, according to their geometric and color continuity. Neighboring elements in chains may geometrically continue one another, and the difference between the parameters of their color profiles may be less than a certain threshold. However, in order to solve a particularly difficult problem in Geometric Modelization, the construction of these chains may differ strongly from the known art.

A known issue with the prior art is that the chains may generally be constructed for one color separation only. This may indeed tend to guarantee a high geometric accuracy for the construction (roughly 1/10 of a pixel, as for edge/ridge elements themselves). But some visually significant edges and ridges may typically disappear in Y (since they may be visible only in contrast to Y). An existing prior art solution for this problem may be to build separate edges and ridges for each color separation R, G, and B. While in such manner all the visually significant edges and ridges may be restored, redundant (but not identical) curves may be introduced, which may render representation cumbersome and hinder subsequent image analysis and processing.

The same problem may arise when edge (ridge) elements from several scales may be considered. Separate curves may be built in each scale, introducing strongly redundant (but not identical) information; alternatively, some visually important patterns may be missed.

Reference is now made to FIG. 11. In accordance with a preferred embodiment of the present invention, a novel process 400 for the construction of chains of EMEs may proceed as follows:

The initial identification (step 410) of the “active EMEs” for a given image, may be performed as described hereinabove in the context of process 300. The output may be a collection Z of directed segments, approximating the curvilinear structure in question with a sub-pixel geometric accuracy, and an approximating EME at each segment of collection Z.

“Bundles” of segments in Z may be built (step 420) according to their geometric proximity.

Preliminary chains may be built (step 430) according to the proximity of the color profiles of the EMEs in the bundles.

Spline curves may then be constructed (Step 440) to approximate the central lines of the preliminary chains.

Final chains of the EME's may be constructed (step 450) with their central segments along the spline curves as described hereinabove.

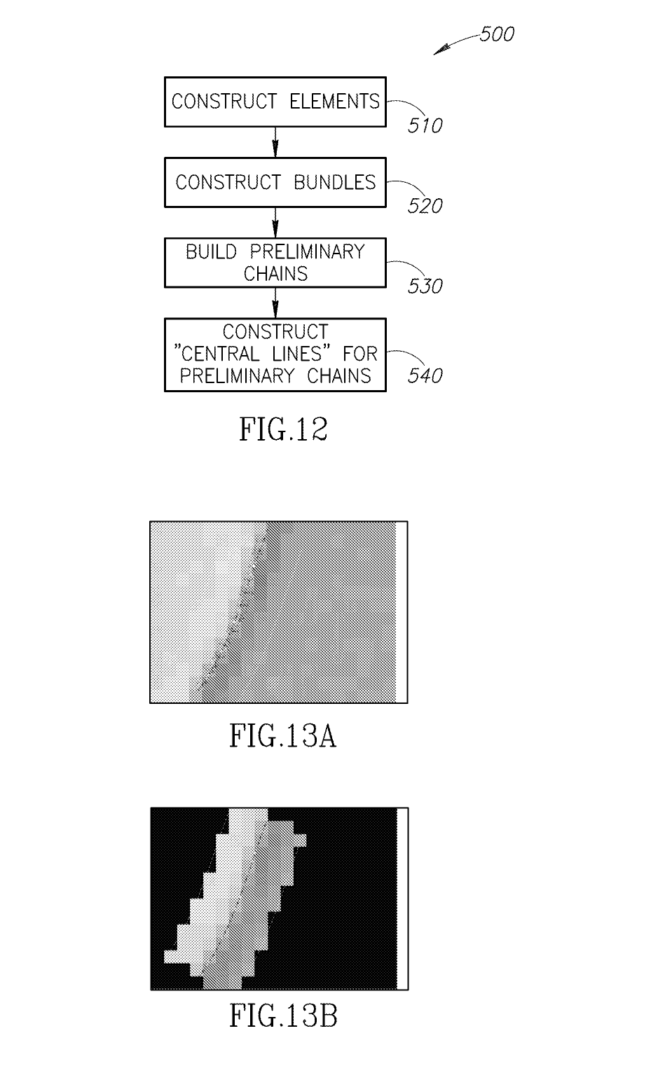

Reference is now made to FIG. 12. In accordance with a preferred exemplary embodiment, where edges and ridges may be the chosen curvilinear structures, chains construction process 500 may be employed to address two issues: to preserve the compactness and coherence of the representation, while ensuring the capture of the visually important patters in each color separation and in each scale:

The edge (ridge) elements may be constructed (step 510) in all the color separations (typically, R, G, and B), and in all the scales (typically, 11×11, 5×5, and 4×4 pixels for edges, 5×5, and 3×3 pixels for ridges). The constructed set may form the set Z of the initially detected EME's.

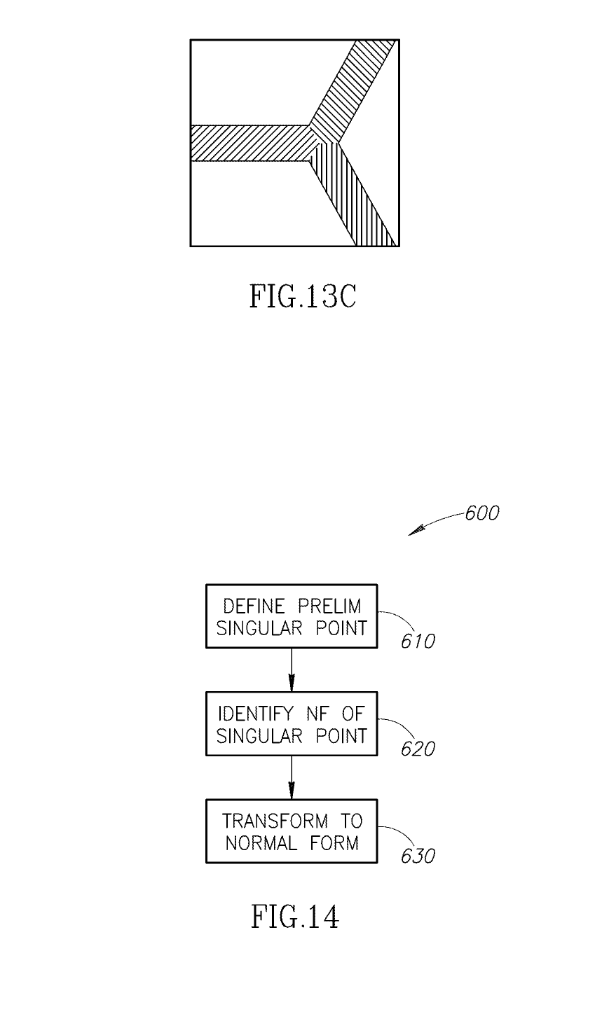

The “bundles” may be constructed (step 520) according to geometric proximity of the elements, separately for edges and ridges. Reference is now made to FIG. 13A. It will be appreciated that, as illustrated in FIG. 13A, in one scale and separation the “preliminary chains” may typically form geometrically coherent lines with an average deviation of the elements from the line of less than roughly 1/10 of a pixel. In contrast, in several scales and separations, the “preliminary chains” may typically form “clouds of elements” with an average deviation of the elements from the “center line” on the order of roughly ½ of a pixel, and even more.

The “bundles” may be constructed for edges and ridges elements together and only later separated into edges and ridges, according to the majority of the elements. This may effectively “close large gaps” in edges and ridges, which may appear when adjacent edges and ridges essentially belong to a single curvilinear structure.

Preliminary chains may be built according to the proximity of the color profiles of the EME's in the bundles. The “central line” may be constructed (step 540) for each “preliminary chain”, which may be a spline curve approximating the elements of the preliminary chain up to a prescribed accuracy “d”. Typically “d” is of order of ½ of a pixel, and the threshold chosen may not be smaller than the threshold in the construction of the preliminary chain. It will be appreciated that the central line may not exactly fit any of the original edge (ridge) elements.

As discussed hereinabove, the central line may strongly deviate (typically, up to ½ of a pixel) from the original elements. However, the use of empiric model elements may compensate for this deviation. EMEs may be constructed according to the central line, as it may happen to be positioned. At the prescribed points x_j on the central line (typically forming a grid with the step dd roughly equal to one pixel) the EMEs may be computed as follows: at the point x_j the central line of the EME is defined just as the tangent segment of the length dd to the central line at x_j. The color profiles (separately for each color separation R, G, and B) in the orthogonal direction to the central line may be constructed as described hereinabove. The profiles may be constructed in one or several prescribed scales. This may complete the chains construction process.

Accordingly, a “chain” may be a spline curve, capturing the position of the edge (ridge) in all the color separations and scales simultaneously, and equipped with the color profiles (i.e., with EMEs) in the prescribed scale at all the points of a certain grid. It will be appreciated that a chain may geometrically deviate from the corresponding edge (ridge) in each specific color separation or scale, up to half a pixel and even more. This may not compromise the accuracy of the representation since this chain may be equipped with the true color profiles. Accordingly the representation may have a very important geometric flexibility: the geometry of edges and ridges may be controlled (to some extent) without affecting the quality of reconstruction. FIG. 13B, to which reference is now made, shows a part of an image, the corresponding elements chains, and the reconstruction result via the color profiles.

In accordance with an alternative embodiment of the present invention, a different implementation of the chain construction process as known in the art may be used. Y, I, Q color separations may be processed instead (or in combination) with the original separations R, G, B. Since usually the Y separation may represent the geometry of the image most accurately, in spline approximation of the bundles of EME's as above, the EME's detected in Y separation may be given a larger weight, so the central line may follow the Y elements to the possible extent. However, in the image areas where the Y separation may be weak or absent, the central line may follow EME's detected in other separations.

In yet another implementation, in order to accelerate the processing, it may be originally performed in Y separation only. However, the color profiles may still be computed for the detected shape curves in all the color separations separately, thus providing an accurate image reconstruction.

In this case in the end areas of the detected edges and ridges the analysis in all the separations may be performed as described above, in order to detect possible continuation of edges and ridges, which is not visible in Y.

An important element of geometric models image representation may be a collection of “singular points” of the image, together with their relationship with the EME chains. The basic role of such singular points may be to capture the “crossings” of edges and ridges (“Crossing Singularities” as discussed hereinbelow) and other types of visual proximities of chains, as well as visually significant changes in the local geometry of the chains and in their color.

The importance of singular points, and, in particular, of the crossings of edges and ridges, may be well known in the art, and many methods for their detection and analysis have been suggested. Detection and analysis of such crossings may also present a major problem in geometric modelization. However, the prior art may typically fail to provide a visually adequate capturing of singularities, especially for high resolution images with intensive fine-scale details. The main reason for this failure may be that their local analysis and approximation with edge and ridge elements typically becomes unreliable when they near the crossings of edges and ridges, their “corners”, or the points of an abrupt color change. Indeed, at such points the color and brightness of the image may not be accurately captured (on 4-5 pixels blocks) by the second and third degree polynomials, because mathematically the crossing pattern may not allow for an accurate approximation of low-degree polynomials. FIG. 13C, to which reference is now made, may illustrate an example of the effects of such a pattern. This may lead to a known issue in the art: in a neighborhood of a radius 2-3 pixels around a typical singular point (a “singular area”) the edge/ridge elements either are not detected at all, or are very “noisy” and unreliable both geometrically and in their color.

Even fourth and fifth degree polynomials may typically fail. Accordingly, computing the third degree polynomial approximation with a normally sufficient resolution (i.e. on 4-5 pixels blocks) may be highly problematic because of the noise robustness problem. Accordingly, the most basic level of existing detection algorithms may typically fail at the crossings and other singular points.

However, the importance of crossings and other singular points in our visual perception is well known. In geometric modelization incorrect interpretation of the crossing geometry may lead to serious visual distortions, in particular, because of the “leakage” of color from one part of the background to another.

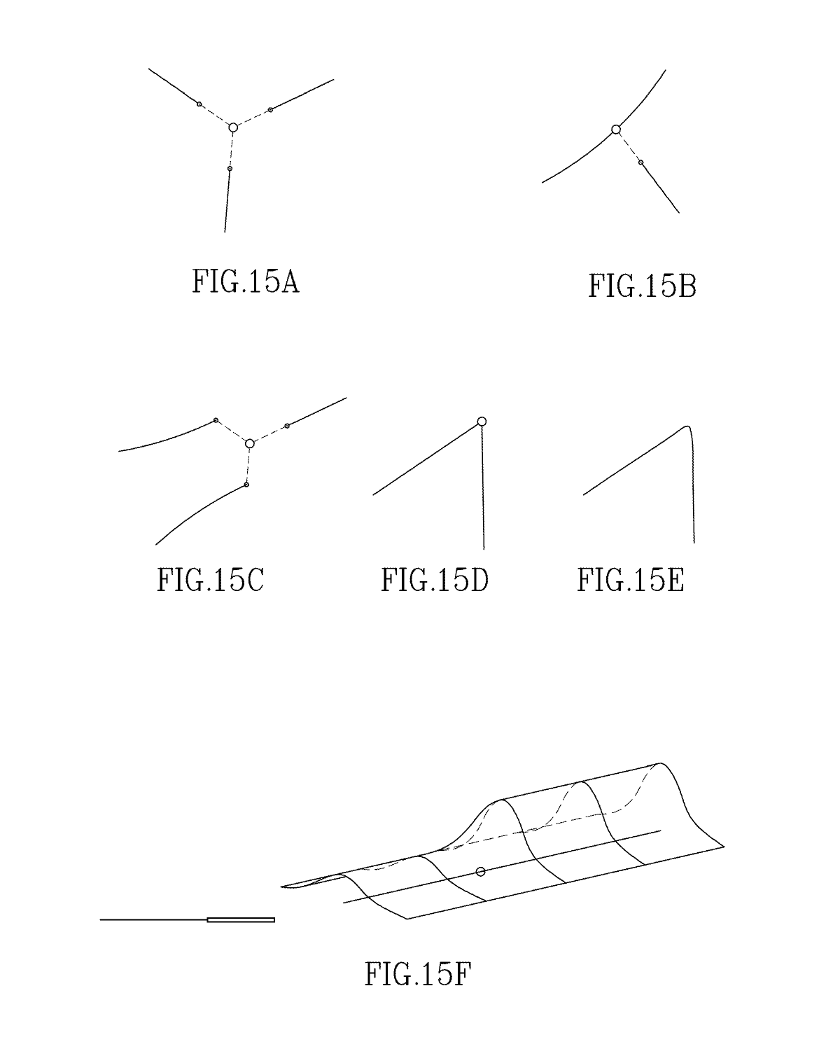

There may be other types of singular points which may introduce basically the same difficulties as crossing singularities. For example, there are “curvature singularities” and “color singularities”. Curvature singularities may occur when the curvature of an EME's chain at a certain point may be too high. In particular, “corners” of the chains may tend to form curvature singularities. Color singularities may occur when the color profile of a chain changes abruptly at a certain point. FIGS. 15D-F, to which reference is now made, show some examples of curvature and color singularities.

Because of the problems described hereinabove, Applicants have realized that these singularities cannot be reliably identified at the level of the initial approximating polynomials. A different approach may be required. Applicants have also realized that it may be possible to leverage the benefits of Empiric Model Elements to solve the problem of singularities. In accordance with a preferred embodiment of the present invention, EMEs may be combined with a novel concept of “Normal Forms of Singularities” to produce a novel process for the identification of singularities. Geometric configurations of end-points of EME's chains (typically, of “skeleton chains” as described hereinbelow) which may be sufficiently close to other EME chains may be indicative of the presence of crossing singularities. Accordingly, crossing singularities may be identified by analyzing EME chains.

Typically, the distance thresholds for the distance between the chains and their crossing points may be 2-3 pixels, to cover the “singular area” as described hereinabove. Accordingly, a scale of 4-6 pixels may be employed to analyze the image structure; a scale which is significantly larger than the scale of the typical empiric model element, thus yielding a relatively “dense configuration of chains”. A singular point may be located at the “center” of such a configuration.

Reference is now made to FIG. 15A. As discussed hereinabove, in chain construction the central lines of the EME's may be approximated with spline curves, thus increasing the robustness of the geometric analysis of the crossings. Typically, such an approximation may “smooth out” irregular geometric behavior of elements in a chain, which may make finding chain intersections more robust mathematically.

Accordingly, once a dense geometric configuration of end-points of EME's chains may have been detected, the spline curves of the chains may be continued analytically, up to a distance “cd” (typically, 2-3 pixels). The intersection points of these continuations may be represented as x_i,j. The collection x_i,j may also be expanded to include the chain's end points themselves. The “preliminary singular point” x may be identified as a central point of (x_i,j), for instance, as the gravity center of (x_i,j). Finally, artificial segments may be added to join the preliminary singular point x with the end-points (or with the interior points) of the corresponding chains.

It will be appreciated that an identified singular point may be just a center point of an artificial segment joining an endpoint of one chain with another chain, or joining two neighboring chain endpoints. FIGS. 15B-G, to which reference is now made, illustrate several examples of image patterns captured by singular points.

In order to identify “Curvature singularities”, crossing singularities “x” detected where just two chains of EMEs come together may be analyzed. If the angle between the continuations of these chains at the crossing point x may be larger than a certain threshold “Th”, then the point x may be identified as a “curvature singularity”. FIG. 15D shows an example of such a “curvature singularity”. Curvature singularities may also appear on a geometrically regular chain, just as a point where the chain's curvature exceeds another threshold “Curv”. FIG. 15E shows an example of this type of a “curvature singularity”.

In order to identify “color singularities”, points on the EME's chains where the color profiles undergo an abrupt change may be analyzed. For example, points where such a change exceeds a threshold “Cs” may identify a color singularity. FIG. 15F shows an example of such a “color singularity”.

In accordance with a preferred embodiment of the present invention, the geometric thresholds in the construction of singular points may depend on the length of the participating chains: the longer the chains, the larger the gaps that may be closed with singular points. Consequently, shorter chains may be less likely to be aggregated in a graph, unless they approach one another very closely.

Reference is now made to FIG. 14. In accordance with a preferred embodiment of the present invention, the preliminary singular points detected as above, may be further processed by a novel process 600 as follows:

First “x” may be defined (step 610) as a “preliminary singular point” as discussed hereinabove. EME's (and, in particular, their color profiles) may be computed along the artificial segments extended from near the preliminary singular point x, detecting them directly from the image, as described hereinabove, taking advantage of the functionality for computing an approximating EME for each prescribed point and direction on the image.

Next the “Normal Form” (“NF”) of this singular point according to the “List of Normal Forms” (“LNF”) may be identified (step 620) by analyzing the geometric structure of the “preliminary singular point” x, and the structure of the EMEs in a vicinity of x. This process may be described in detail hereinbelow as part of the discussion of “normal forms and normalizing transformations”.

The actual “preliminary singular point” x may be transformed (step 630) to its normal form NF by finding the parameters of the “normalizing transformation” (“NT”). There may be two options for performing this last step: either the geometry of the preliminary singular point x and of the EMEs in a vicinity, or of the original image (also in a neighborhood of x) may be used to find the best approximation for NF (with respect to the parameters of the normalizing transformation NT). The process for “normal forms and normalizing transformations” may be discussed in detail hereinbelow.

After a predetermined number of iterations of these steps may have been completed, the “preliminary singular point” x may be defined as a singular point and it may be considered together with the attributes found in these steps.

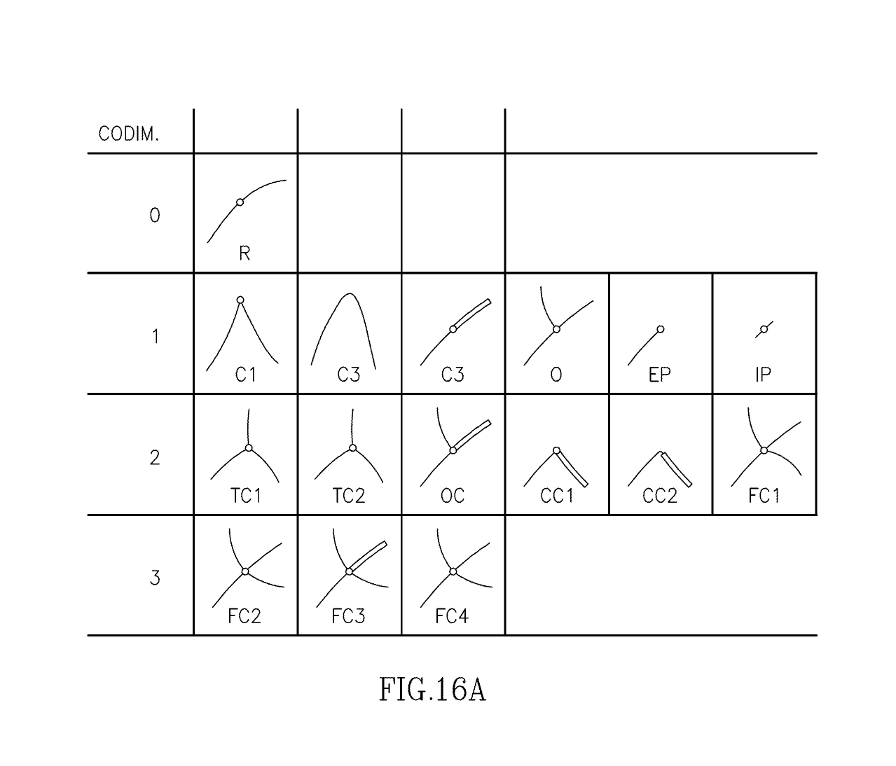

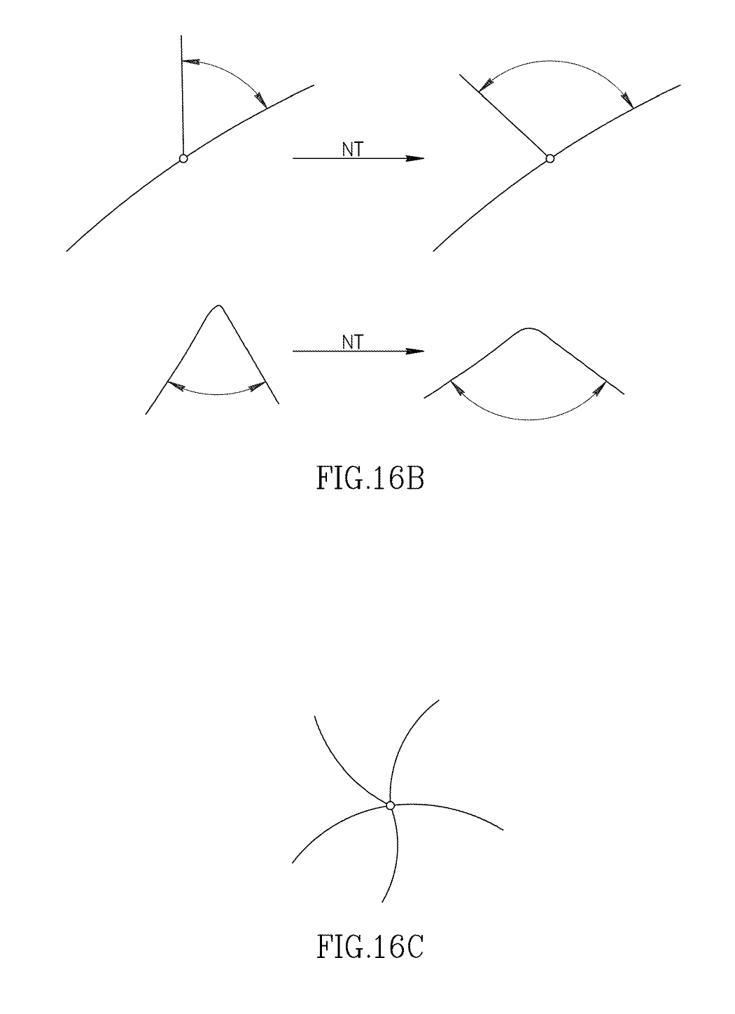

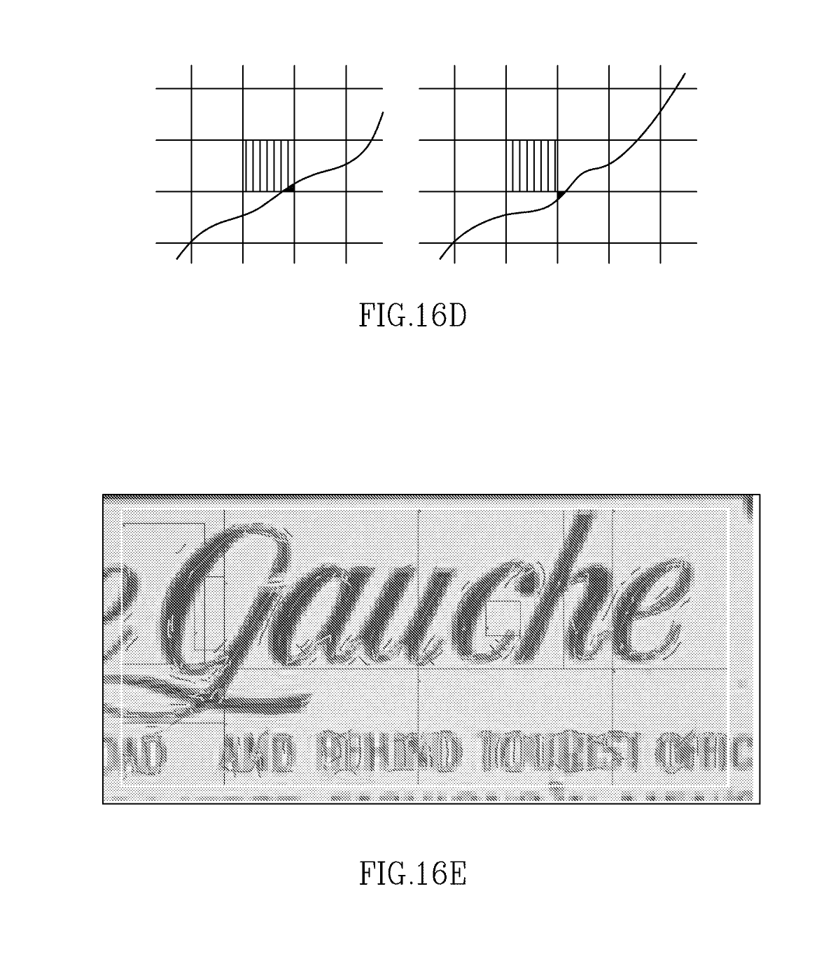

A “Normal Form” (NF) may be an exemplary configuration of chains of EMEs in a neighborhood of a singular point, representing a typical pattern of a singularity. NFs may be organized into a “List of Normal Forms” (LNF). It will be appreciated that the Normal Forms in a given LNF may be chosen according to the requirements for a particular application. FIG. 16A, to which reference is now made, presents a beginning of an exemplary LNF for a general purpose image cell modelization application.

An LNF may possess a certain natural hierarchy: some of its types may be refinements of the others. The exemplary LNF in FIG. 16A may share the hierarchical structure of the list of the Normal Forms of singularities in Mathematical Singularity Theory. However, the structure of an actual image may be determined by a combination of too many factors to follow exactly simple mathematical principles. Consequently, while an LNF may initially be based on a list of standard normal forms, in practice it may be constructed empirically, according to the requirements of a specific application.

A singular point x may be said to have a normal form NF if it can be obtained from the normal form NF in the relevant LNF by a certain allowed type of transformations T which may be called “Normalizing Transformations” (NT). NTs may usually include geometric transformations of the neighborhood of a singular point, together with the transformations of their color profiles. FIG. 16B, to which reference is now made, may present some examples of the normal forms of the crossing and curvature singularities, and their normalizing transformations. The last may be reduced in this example to changes of the angles of the incoming chains at the singular points, and to uniform resealing of the color.

FIG. 16C, to which reference is now made, may present an example of a singular point which may be unusually complicated with five branches; its normal form is not covered by the LNF of FIG. 16A. It will be appreciated that an appearance of even four branches at a crossing singular point may be a rare event. Typically when an object may occlude another one in an image, the object boundaries may form triple crossings with the chains on the occluded object. A crossing singularity with four may require that a chain on the occluding object come exactly to the same position on the boundary as another chain on the occluded one. The probability of such an event may be very low. Moreover, it may also be a rare event that a chain on the occluding (or the occluded) object comes to the boundary exactly at a “curvature singularity” of the boundary.

The number of independent conditions that may have to be satisfied in order for a singularity of a certain type to be formed may be referred to as the codimension of this singularity. The hierarchy in the exemplary LNF of FIG. 16A may be determined by the codimension of the singularities. Accordingly, in the hierarchy in the LNF of FIG. 16A, triple crossings with two branches forming a nonsingular line may be higher than a triple crossing with all of the angles different from 180 degrees.

The number of branches at a singular point may be the first indicator used to identify the normal form of a given singularity. For example, referring to the LNF of FIG. 16A, a single point may indicate an isolated element IE. One branch may indicate an end point EP. Two branches may indicate a regular point R, a “curvature singularity” C1 or C2, a “color singularity” C3, or combination types CC1 and CC2 (which may indicate a combined curvature and color singularity). Three branches may indicate an “occlusion singularity” of type O, a true “triple point” (TC1, TC2), or an “occlusion-color singularity”, OC. Finally, four branches may indicate the last NF's in the list, of the types FC1, FC2, FC3. This may complete identification of the geometric type of the singular point (as per the exemplary LNF of FIG. 16A—other LNFs are of course possible).

Reference is now made to FIG. 16B. The geometric part of the normalizing transformation NT in each case may just be the transformation bringing the straight segments of the normal form into the actual spline curves of the incoming chains at the singular point. The color part of the transformation NT may transform the constant color profiles of the normal form into the color profiles of the EMEs of the incoming chains. For a given singular point x and its incoming chains of EMEs, both transformations may be easily computed via existing methods well known in the art.

In accordance with a preferred embodiment of the present invention, singular points may be considered as a part of a visually prominent geometric structure of the image formed by relatively long and visually distinguished chains of edge/ridge elements. This structure may be referred to as a “skeleton” of the image, as opposed to the “model texture”. Appearance of a large number of singular points in the texture areas may be geometrically misleading; accordingly, detection of singularities may be performed to detect just the skeleton. It will be appreciated, however, that as will be discussed hereinbelow, separation of the models into the skeleton and the model texture may be based on graphs of chains, whose construction may, in its turn, based on singularities.

The first step in resolving this issue may be to perform identification of “prominent chains”. First, the chains may be ordered by their length, and a length threshold “D” and a distance threshold “ddd” may be fixed. Next the chains may be processed in order of decreasing length. The empiric model elements which do not belong to the chain under processing, but are closer to it than ddd may be marked. Finally all of the EME's inside the chains shorter then D, may also be marked. Only non-marked curves-elements may participate in the construction of the “prominent chains”, and only skeleton chains may be used in the construction of singular points.

Singular points in image modelization may have several functions. For example, a typical scale of the area controlled by singular points may be 3-5 pixels. One of important functions of singular points may be to close the gaps of this scale in the geometric net of chains. It will be appreciated that in the chains themselves, a much finer scale of geometric continuity may be required: roughly 0.5-1 pixel (as described hereinabove). In contrast, the endpoints of relatively long chains may be visually perceived as geometrically associated” at much larger distances, on the order of at least a few pixels. Singular points may translate this “geometric association” into the language of geometric models.

Accordingly, the geometric thresholds in the construction of singular points may depend on the length of the participating chains: the longer the chains may be, the larger the gaps that may be closed with singular points. As they may have associated color profiles, singular points may provide robust color information at the crossing areas where the usual edge or ridge elements may be irrelevant. In such manner they may complement the functionality of existing local models and complete the list of elements for image modelization.

Another important role of singular points may be to make the geometric partition of the background provided by the edges and ridges more robust. It will be appreciated that as discussed hereinabove, relatively large gaps between chains of edge/ridge elements may be closed at singular points, thus preventing “leakage” of the color from one part of the background to another. Therefore, introducing singular points geometric modelization may resolve one of its inherent quality problems.

Singular points may also help in further processing and encoding of modelized (vectorized) images For example, crossings of edges and ridges may be treated only very partially in the prior art. Consequently, prior art encoding methods may suffer from serious stability problems. It will be appreciated that the encoding of the background data in such situations may require an accurate description of the topology of the image partition by the edges and ridges. With the prior art, if the proximities in a scale of a few pixels between edges and ridges may not be explicitly captured as singular points, then the topology of the image partition by the edges and ridges may change as a result of computational errors and/or of quantization of the geometric data. FIG. 16D, to which reference is now made, may illustrate this problem.

One more important function of singular points may be to organize the chains of EME's into “graphs” and to form the image “skeleton” as described hereinbelow. Such graphs may significantly simplify image analysis and patterns recognition by capturing visual proximities of the chains. Reference is now made to FIG. 16E, which illustrates a collection of letters in different scales together with the superimposed graphs of chains representing these letters. The topology of these graphs may strongly resemble the letters on the image. It will be appreciated that the graphing method may not have used any preliminary information on the presence of letter—like patterns on the image. The structure of the skeleton graphs may be a powerful tool for pattern recognition even without preliminary input.

Singular points may play a very important role in image analysis, in particular in regard to “layers separation” and “depth detection” operations where determining a relative depth of different part (layers) of the image may be required. For example, it is well known in the art that the triple crossing (“O” type in list LNF of FIG. 16A) may usually represent an occlusion pattern where the smooth edge bounds the occluding layer, while the adjoining edge (ridge) segment may belong to the texture of the occluded layer. However, a more accurate description of singularities may help in a more accurate distinction between various cases. For example, the presence of a combination of an occlusion singularity and a color one (OC in FIG. 16A) may make the occlusion less probable, since an exact coincidence of the color singularity on the occluding layer's boundary, and the crossing point with the edge (ridge) on the occluded layer, is a rare event. On the other hand, OC-type singularities may be more typical for one layer texture patterns. The same may also be true for TC1, TC2, and FC1-FC4 types of singularities.

The extended color profiles which form an important role in the normal forms of singularities, provide additional important information in the depth analysis. In particular, typically the color profiles of the edges bounding the occluding layer may be sharper on the side of this occluding layer than on the side of the background. This fact may provide an additional important clue in the relative depth analysis. This test may be applied not only at singular points, but along edges.

After the singular points may have been constructed, the chains of edge and ridge elements may now be naturally aggregated into connected “graphs” G_j. For each singular point x there may be elements chains that enter x. In this manner, all the elements chains, together with all the singular points, may form a graph G, the singular points being the vertices of the graph G, and elements chains being the edges of G. The sub-graph of connected components of G may be denoted by G_j, and the vertices of G_j may be denoted by V_ji, and its edges by E_ji.

As disclosed hereinabove, the geometric thresholds in the construction of singular points may depend on the length of the participating chains: the longer the chains may be, the larger the gaps that may be closed with singular points. Consequently, shorter chains may be less likely to be aggregated in a graph, unless they may approach one another very closely.

The length l(H) of the Graph H may be defined as the sum of the lengths of the chains inside the graph. A “skeleton” may now be defined for the image.

For a given threshold “ds” the “ds-skeleton” S_ds of the image (or simply the skeleton S of the image) may be defined as the union of all the graphs G_j with l(G_j)>ds. A typical value for the threshold ds may be between 3 to 16 pixels. In particular, the graphs G forming the skeleton of the letters hereinabove (FIG. 16E) may have a length l(G) of order 8 pixels. The threshold ds may also be chosen according to the local statistics of the image: in dense areas it may be larger, while in relatively empty areas it may be smaller. Accordingly, a short graph may be more likely to enter the skeleton if it may be largely separated from the other chains.

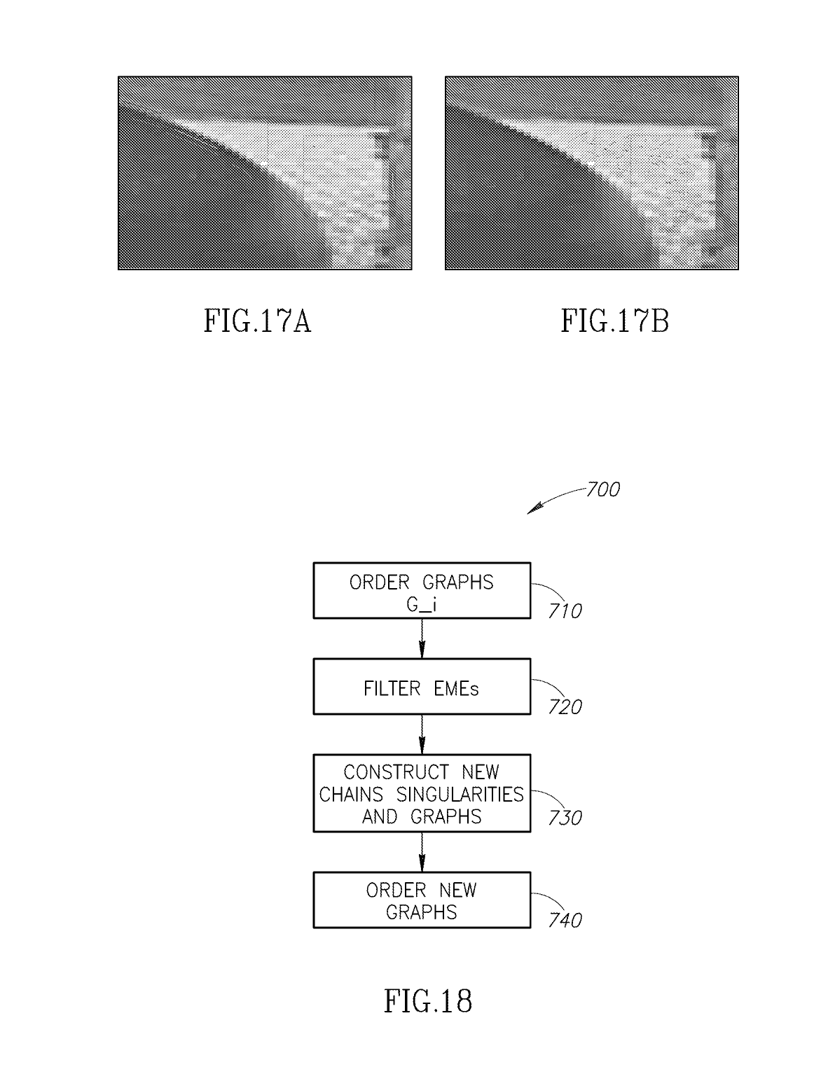

All graphs G_j that may be shorter than threshold ds may form the “model texture” MT. FIGS. 17A and B, to which reference is now made, illustrate an exemplary separation of skeleton chains of EMEs (FIG. 17A) and texture chains of EME's (FIG. 17B). It will be appreciated that separation of the EME chains and their graphs G_j into the skeleton and model texture may play a central role in many possible construction; in particular, in background construction, and in the completion of occluded areas.

A certain redundancy may be built into the construction of active EMEs: initially, they may be constructed independently for different color separations and in different scales. Some of this redundancy may be eliminated in the process of construction of the EME's chains: the “clouds of EMEs” may be replaced with spline central curves. However, some EMEs which might not be located in these “clouds” may still present redundant geometric and/or color information. Usually such EMEs may be located in close vicinity to other EME's chains. However, for small chains the question of redundancy may be difficult: a decision may be required for which of mutually overlapping small chains to keep. This problem may be addressed hereinbelow in the context of “model texture filtering”.

For a given threshold fd, the fd-neighborhood S_sd of the skeleton S may be considered, and for each empiric model element U in S_sd, (where U may not be in the skeleton), the following operation for “verification of the model redundancy” may be performed:

EME U may be omitted from the data and the image I′ may be reconstructed (locally) from this reduced information. Then the image I may be reconstructed (locally) from the complete data, including U. If the difference (L̂2 or maximal) of I and I′ may be less than a certain “quality threshold” q, U may be eliminated as a redundant EME. However, If the difference of I and I′ may be larger than q, U may remain in the data. This procedure may be applied not only to an empiric model element, but to any model or combinations of models. In particular, as will be discussed hereinbelow, it may be applied to model texture graphs G_i.

It will be appreciated that as a result of the filtering procedure, some chains in the model texture may be broken since some of their EMEs may “disappear”.

Reference is now made to FIG. 18 which illustrates a novel model texture filtering process 700, constructed and operative in accordance with a preferred embodiment of the present invention. Model Texture filtering may be performed in generally the same manner as the filtering near the skeleton. The only material difference may be that inside the model texture there may not be a clear preference for some chains over some others. In accordance with a preferred embodiment of the present invention, filtering of the redundant EMEs in the model texture may proceed as follows:

All the graphs G_j in the model texture may be ordered (step 710) according to their decreasing length l(G_j).

The EMEs of all the G_j may be filtered (step 720) as described hereinabove in the context of “verification of the model redundancy”. The filtering may start with the graph G_s of the maximal length and proceed in descending order.

After the redundant EME's may have been eliminated from the data, new chains, singularities, and graphs G′_j may be constructed (step 730) from the remaining EMEs. It will be appreciated that as discussed hereinabove, singularities in the model texture may play a much less prominent role than in the skeleton.

The new graphs G′_j may be ordered (step 740) according to their decreasing length l(G′_j), and all the steps above may be repeated with the graph of the maximal length G′_r. However, the first graph G_s may not participate in these procedures. In this way the filtering may be continued until the elimination of the last redundant EME.

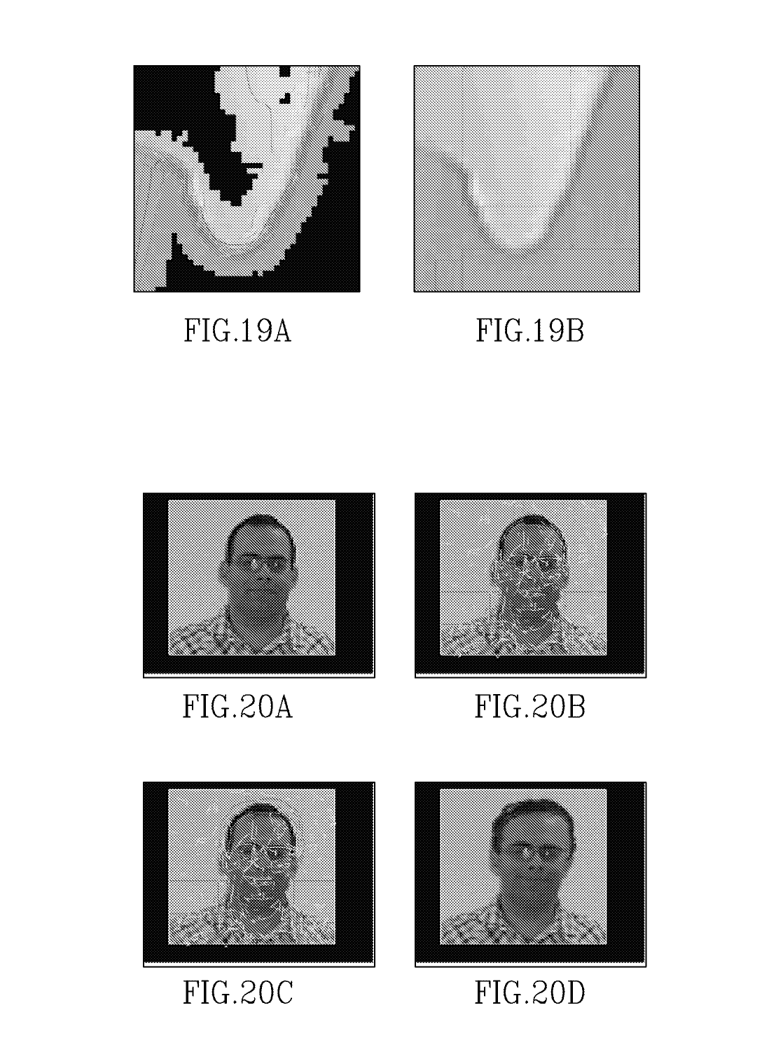

Reference is now made to FIG. 19A. The “skeleton control area” (SCA) may be the union of the control areas of all the EMEs in the skeleton of the image. The “texture control area” (TCA) may be the union of the control areas of all the texture EME's in the image. The “model control area” (MCA) may be the union of SCA and TCA. All of the pixels not covered by the model control area may together form the background area BA.

Construction of the background may strongly differ from that of prior art modelization methods. For example, in one such method the background data may be reconstructed from the edges margins via solving the Dirichlet boundary problem for the Laplace equation. While providing a largely satisfactory visual quality, this method by definition cannot guarantee an accurate reconstruction of the smooth areas.

In contrast, according to another prior art method the background construction may first require a subdivision of the entire image into cells (for example, 6×6 pixels), and then an accurate geometric partition of this cells by the edges and ridges. Consequently, this method may suffer from serious stability problems: the topology of the cells partition may change as a result of computational errors and of quantization of the geometric data. Any such event may lead to an unrecoverable destruction of the image representation: the background data may be stored in the memory according to the topology of the cells partition by edges and ridges. Any change in this topology may render the reconstruction impossible.

An objective of the present invention may be to achieve a required accuracy in a representation of the background area while preserving robustness and compactness of the data. In accordance with a preferred embodiment of the present invention, a “signal expansion” procedure may be employed to achieve this goal by identifying the connected components of the background.

The signal sent from a certain initial pixel may not cross the skeleton control area SCA, but it may cross the texture control area TCA. This procedure may be started with a certain pixel out of the model control area MCA. After the signal expansion from this pixel stops, it covers a connected component in the image. Next, another pixel out of MCA may be chosen and signal expansion performed from it, etc. The connected components in the background area BA obtained in this manner may further be covered by bounding rectangles. Finally, a polynomial approximation of the image color data may be constructed for each rectangle. In the reconstruction process these steps may be performed in reverse order and direction.

Reference is now made to FIG. 19B which illustrates an exemplary image and its background partition. A representation of the background may comprise the following elements: a collection of “background rectangles” covering the background area. Some of these rectangles may overlap. In each background rectangle an “initial pixel” may be marked, and in each background rectangle an approximating polynomial of a fixed degree d may be specified (usually d=1).

There are several methods known in the art for separating edges and texture and then capturing texture with standard imaging tools like wavelets. For these methods it is generally necessary to separate the “structural” visually important edges and ridges from those that appear in the texture area. In accordance with a preferred embodiment of the present invention, this separation problem may be solved by constructing the singular points and the image skeleton. In such manner, known methods for texture capturing such as wavelets may be applied to the complement to the skeleton area, i.e. on the background.

Another difficult problem which may arise in an attempt to combine model-based representation with linear methods like wavelets expansion, is that linear methods may tend to behave poorly near edges and ridges. Accordingly, it may be important to cover the entire neighborhood of the edges and ridges by these models. In accordance with a preferred embodiment of the present invention, providing a reliable image representation by the EMEs profiles in the entire neighborhood of the skeleton (the “skeleton controlled area” above) may solve this second problem as well. Known linear approximation methods may be applied on the complement to the skeleton controlled area, i.e. on the background.

As discussed hereinabove, an expected advantage of applying image processing operations directly on modelized images in a geometric models format is that this format may provide a generally faithful image description in the form of a “high-level geometric modeling language” (HLGML). Any image analysis or processing task that may be described in this language may be easily performed on geometric models, without processing the actual pixels. Consequently, definition and implementation of many important image processing operations may be much easier using the geometric models format instead of pixel level operations. The following may represent a series of examples of such “high level” commands.

The structure of the disclosed model-based representation may allow for almost unlimited modifications of the geometry of the edges and ridges (at least until new crossings are created). This may be accomplished interactively, as detailed hereinbelow in a number of exemplary implementations.

The main steps of image morphing without depth separation may be as follows: For skeleton “deformations” a user may interactively prescribe a morphing and a standard mathematical extension F of the prescribed morphing may be applied to the entire image. Then F may be applied to each geometric parameter of the skeleton in turn: chains of elements, singularities, and the width of the color profiles. The brightness parameters of the color profiles may be preserved.

Texture morphing may be accomplished in generally the same manner as for the skeleton, with the following additional restriction: the texture models must remain under the morphing F in the same parts of the background as they may have been before morphing. (This condition may be violated since F may be not exactly a one-to-one transformation of the image, and because of numerical inaccuracy). To achieve this, the texture models may be perturbed, if necessary, and pushed back to their background domains. Reference is now made to FIGS. 20A-D. FIG. 20A may represent the original image; FIG. 20B may represent the image's model representation superimposed on the image; FIG. 20C may represent geometric deformation of the model; and FIG. 20D may represent the resulting deformation of the image.

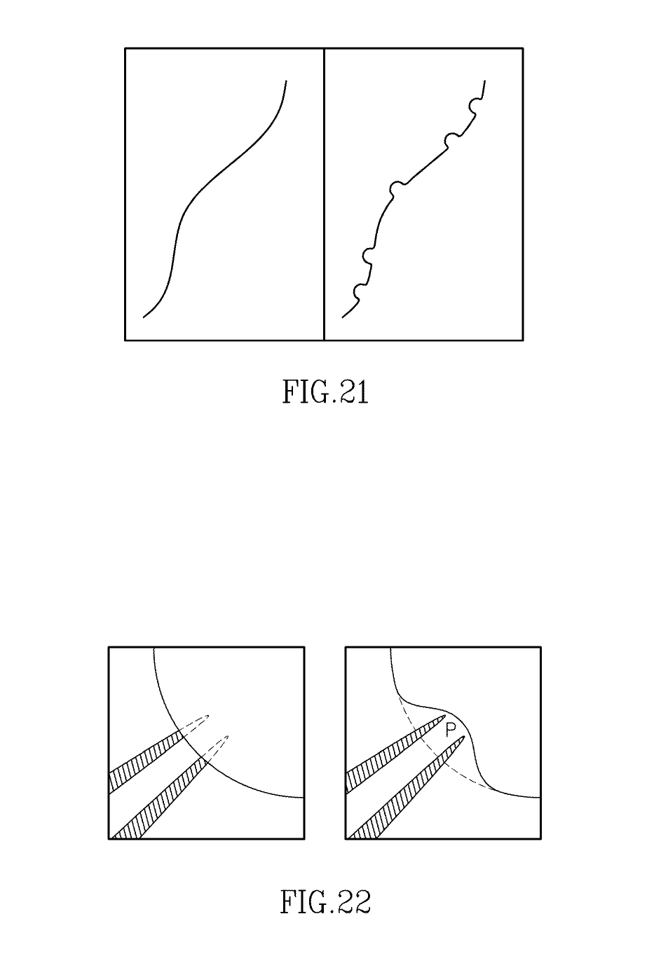

Alternatively, HLGML commands may facilitate certain geometric operations which may be difficult to perform interactively. For example. “Increase twice the curvature of all the edge segments, where their curvature exceeds a certain threshold”. FIG. 21, to which reference is now made, may illustrate the “before” and “after” of another such example. “Put bumps of the width 4 pixels and height 3 pixels in a distance 10 pixels one from another along the chosen edge (ridge).”

HLGML may also support image morphing while preserving depth separation. This specific interactive option may enable a user to mark “the background side” at a certain edge on the image, and then to drag this edge into a desired position. The texture on the foreground side of the edge may be morphed accordingly, while the texture on the background side may be either occluded or completed, according to the direction of the edge's motion.

This may be an important operation which may significantly simplify some high-level image processing operations. It may be achieved via combining the non-separated morphing described hereinabove, and image completion described hereinbelow. Reference is now made to FIG. 22. First of all, all the models on the foreground side of the deformed object may be morphed according to the object (edge) deformation, as described above. It may now be assumed that the edge motion may open a certain previously occluded part P of the image. Then P is bounded on one side by the new edge and on the other side by the old one. So the texture (visible on the image) may be extended from the background side of the old edge to P, using an occluded area completion algorithm such as that described hereinbelow. If the edge motion causes occlusion of a certain part Q of the image, all of the occluded models in Q may simply be eliminated.

When using the normal forms of crossing singularities as described hereinabove, image morphing while preserving depth separation may be extended to an almost completely automatic “layers depth separation” operation. As noted hereinabove, a triple crossing of the type “O” (a smooth edge chain and another chain incoming with a nonzero angle) may typically indicate an occlusion: the smooth edge may bound an occluding layer, while the other (half)-chain may belong to the semi-occluded one. Using this observation we may automatically mark the foreground and the background layers on the image. Image morphing preserving depth separation may be performed relatively easily based on this marking. Experiments show that only minor intervention of the user may typically be required to complete the depth separation.

In many applications it is important to identify image layers according to their relative depth (in particular, the foreground and the background objects). In accordance with a preferred embodiment of the present invention a powerful automatic-interactive relative depth identification tool may be provided for this task. This tool may process image layers in the following manner:

First, the skeleton edges and ridges may be analyzed according to the type of singularities that may appear on these edges and ridges. As explained hereinabove, this analysis may typically facilitate the finding of occlusion patterns on the skeleton.

This information is often sufficient to enable an automatic algorithm to define the closed layers and to order them according to their relative depth.

In cases where the algorithm fails to complete the above task of layers separation, it may indicate edges identified as problematic to the user. The user may then provide additional information as may be necessary, for example, relative depth and occlusion pattern of a specific edge, its continuation and completion, etc.

If necessary, the relative depth layers identification tool may be configured with segmentation algorithms known in the art in order to simplify identification of the layers.

It will be appreciated that this tool may provide the relative position of different layers (their occlusions), but not necessarily their true depth.

In accordance with a preferred embodiment of the present invention, a geometric depth determining utility may be provided to represent 3D geometric data on the image with the same geometric models that may be used to represent the picture itself (i.e. its brightness and color). The depth information may be associated with geometric models in the generally the same manner as for each of the colors R, G, B. It will be appreciated that other than the different dynamic interval, the image depth may appear in the format as just another color. Accordingly, in an exemplary standard three color configuration, the geometric models may have information for four colors: R, G, B, and D (depth).

The depth information necessary for such a representation may be obtained in different ways:

Various 3D sensors (or other methods, like stereo-analysis) known in the art may be used to find the depth of each pixel on the image, resulting in a “depth image”. This “depth image” may be processed (separately) in generally the same manner as described hereinabove to produce its model-based representation. It will be appreciated that this approach may yield “depth chains of EME's” that may differ from the “color chains” of the same image.

Alternatively, the depth data may be provided as part of a general image description, in the same manner as the colors. In accordance with a preferred embodiment of the present invention, the depth, edge, and ridge elements may then be constructed and included in the common “elements bundles” together with the edge and ridge elements. The final chains may be further constructed as described hereinabove. These chains serve all the color separations, including depth, at the same time. However, as described hereinabove, the color (depth) profiles of the EMEs along these chains may be computed (via the least square approximation) separately for each color, and for the depth.

The feasibility of this approach may be based on the observed fact that the edges, ridges, and other curvilinear structures on the images largely represent the geometric features of the objects. Accordingly, these lines, and the edges and ridges of the depth function itself, may typically be geometrically close to one another.

In accordance with another preferred embodiment of the present invention, color edges and ridges may be used to determine depth. However, as above, the depth profiles of the EMEs may be computed from the depth data. This approach may be extended to situations where direct depth measurements may not be available. Instead geometric information, provided by geometric models, may be used to reconstruct the depth of the image. In accordance with a preferred embodiment of the present invention, the relative depth layers identification tool, as described hereinabove, may be used. This tool may provide the relative depth of different layers, but not with their true depth. Next “shape from shading” methods known in the art may be employed to approximately reconstruct the true depth of the geometric models on the image.

In accordance with another preferred embodiment of the present invention, “synthetic” depth information may be “inserted” into the models. Such “synthetic” information must respect the relative depth of the layers, but otherwise it may be rather arbitrary. “Synthetic depth” may be applied to facilitate simulations of 3D motions of the objects on the image.

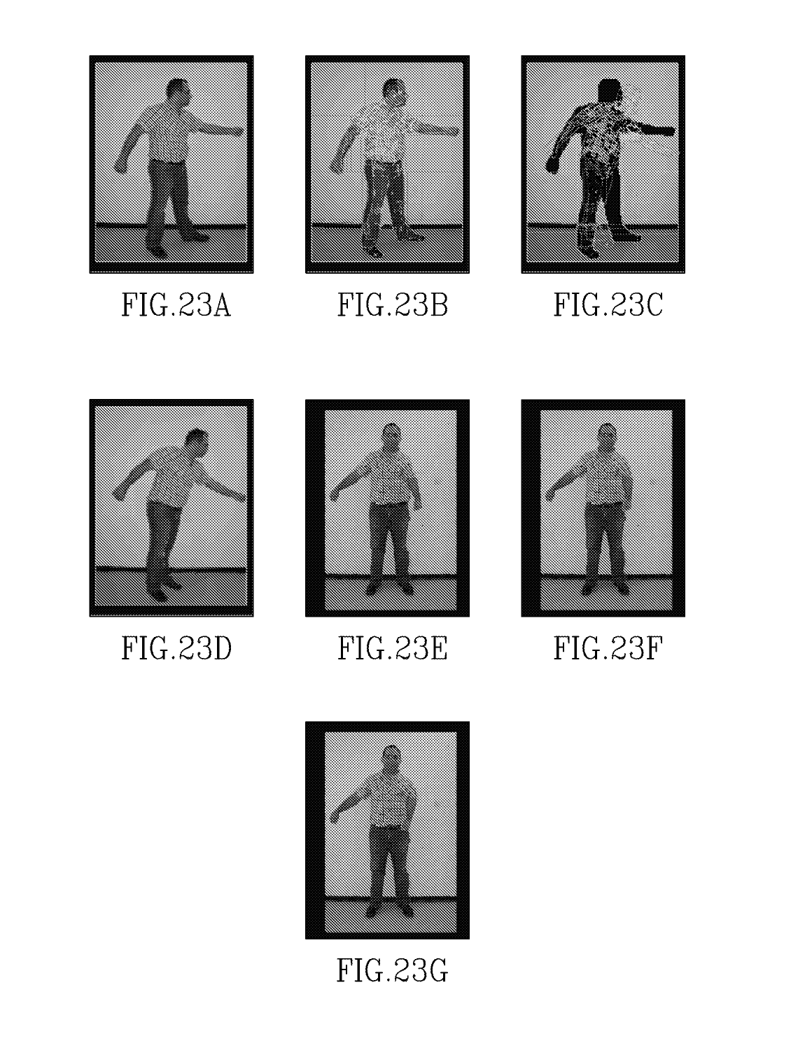

Each of the layers may be dragged and geometrically transformed into a new position. Animations may be produced as usual by interactively defining layers positions at the key frames, and then interpolating the layer's motion to the entire frame sequence. FIGS. 23A-D, to which reference is now made, together illustrate an example of layers manipulation. FIG. 23A presents an original image. FIG. 23B shows its modelization, separated into layers with different depth. FIG. 23C shows a new position of the model layers. FIG. 23D presents the corresponding pixel image. FIGS. 23E-G present three frames from another animation produced as described above.

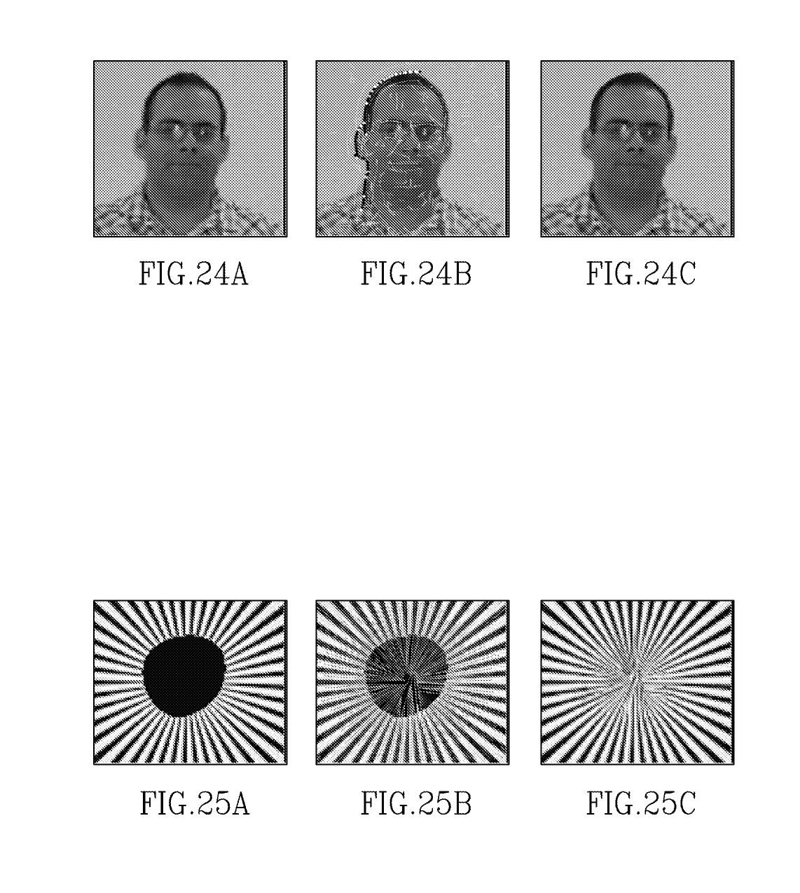

HLGML may support the processing of color cross-sections. This kind of operation may be easily expressed in high level commands. In accordance with a preferred embodiment of the present invention, a cross-section control may be implemented using HLGML. For example, the cross-section control may be used to interactively change the width of the cross-section and/or its brightness at the control points (in each color). Similar operations may be performed automatically as well. For example, the cross-section control may be used to effectively filter an image with high pass and/or low pass filters. High pass filter functionality may be provided by automatically multiplying the width of all the color profiles by variable “a” (where a<1) while amplifying the color parameters of the profile by “b” (where b>1). This may result in an increased sharpness of the entire image. Low pass filter functionality may be providing by defining a>1, and b<1, which may yield an image with reduced sharpness. The effects of such operations may illustrated by reviewing FIGS. 24A-C, to which reference is now made.

FIG. 24A may represent the models superimposed with the same original image as in FIG. 20A. The forehead edge to be edited is shown.

FIG. 24B may represent the image of FIG. 24A after passing through a high pass filter to increased sharpness of the marked edge.

The visual effect of these operations allows us to control sharpness, brightness, and color of edges and ridges. More complicated alterations of the color cross-section may also be possible, like sharpening only on one side of the edge, and other, although their visual interpretation is not always straightforward.

In accordance with a preferred embodiment of the present invention, the cross-section control described may be capable of selectively applying sharpening/unsharpening operations to the selected edges and ridges on the image. For example, using HLGML the following operations may be defined: Reduce twice the width of all the edges and ridges shorter than 3 pixels. This operation may lead to a strong sharpening of the texture areas, while “long” edges and ridges may remain untouched. In another example, the operation requested may be: Reduce twice the width of all the edges and ridges longer than 30 pixels, while amplifying their brightness by 1.5. This operation may lead to a strong sharpening of the “long” edges and ridges, while the texture areas may remain untouched.

In accordance with another preferred embodiment of the present invention, the cross-section control may be capable of providing Image zoom while preserving sharpness of the details. Preservation of sharpness while zooming is a known problem in the art. It will be appreciated that the disclosed image representation based on geometric models may be naturally scale-invariant. To zoom A times it may be necessary to just multiply all the geometric parameters of the models by A, while preserving the original brightness parameters. This may correspond to a usual zoom A times. However, if the width of the color cross-sections are also preserved unchanged, the resulting zoom may preserve the original sharpness of the edges and ridges; including all of the image patterns that may have been captured by the geometric models, and excluding the background. The patterns captured by the background may be stretched A times as they were in the prior art. It will be appreciated that more sophisticated selective adjustments of the color cross-sections may be applied to improve the quality of the resulting image.

The problem of image completion typically appears when a foreground object partially occludes background objects. In many applications (especially, in photo-animation, but also in image analysis, visual search, etc.) it is important to reconstruct the occluded parts of the background objects. Of course, this problem mathematically is “ill-posed”: there is no way to restore uniquely the unknown image parts. However, practically what is needed is a “plausible” reconstruction. FIGS. 25A-C, to which reference is now made, may together represent an exemplary instance of a typical completion problem.

There are many publications on the completion problem and many reasonably reliable prior art completion methods. However, completion may remain a challenge, especially if an entirely automatic completion to relatively large occluded regions may be required (as frequently may happen, for example, in photo-animation). One of the main difficulties in completion is that the known image parts which are to be “continued” often contain image patterns in different scales. It is intuitively clear that in this case each pattern may have to be extended separately, according to its scale. However, this operation may be difficult to perform with prior art pixel-based image representation.

Some approaches suggest to first extend the “structures” interactively or automatically, and then to extend texture. Applicants have realized that the disclosed geometric modelization may take advantage of, and perhaps even enhance the effectiveness of, such approaches. In accordance with a preferred embodiment of the present invention, an occluded area completion tool may be provided. Such a tool may automatically extend the image skeleton S (the “structure”), before extending the texture. It will be appreciated that a combined interactive-automatic completion may be naturally implemented in this format as well.

The disclosed modelized representation may be especially convenient for the completion of occluded areas. The geometric models format may be well adapted to the sort of processing required to perform completion. Image skeleton S may capture medium-large scale visual patterns, model texture MT may capture fine to medium scale patterns, and the background may capture image regions with a slow change of the color. Each of these structures may be extended separately, according to its scale while maintaining coordination with the other two.

FIG. 25B, to which reference is now made, may illustrate geometric models representation of the image as per the previous example, and the continuation into the occluded area, as described below. The occluded area completion tool may use the following algorithm for completion:

The tool may analytically continue the spline curves representing the central lines of the EME's chains in the image skeleton S into the occluded area, up to the prescribed distance “d”, where “d” may express the desired depth of the completion. It will be appreciated that the extended spline curves may collide. If this occurs, the angle between these curves may be checked. If the angle may exceed 90 degrees, the continuation may stop. Otherwise curve may be continued in the bissectrice direction up to the depth d.

Models texture MT and the background may be extended according to the background partition by the skeleton. To achieve this, strips may be created around the boundary between the regular pixels, and the occluded pixels. The width of these strips may be a given parameter, and they may be created separately in each domain of the complement to the extended skeleton. Each strip may be divided into two sub-strips, the first may be located in the domain of regular (non-occluded) pixels (red points), and the second may be located in the domain of the occluded pixels (green points). In order to complete the texture objects (models) these objects may be copied via blocks of s×s pixels (typically s=5), from the red sub-strip to the green sub-strip, randomly choosing the block position inside the red strip.

After the random texture copying process may have finished, there may be some regions in the originally occluded area (to be completed) which may not covered by the control area of any curve-element. These regions may be completed by painting their pixels according to the color of neighboring pixels. FIG. 25, C presents the result of a completion procedure.

To perform an interactive completion, the shape curves in the margins of the area A may be marked to be analytically continued into A. The “depth” of the continuation may also be controlled interactively. If necessary, the geometric shape and the color profiles of the continued curves may be edited. The model texture may be extended automatically to A according to the background partition provided by the extended shape curves. If necessary, the model texture may be edited and corrected interactively.

U.S. patent application Ser. Nos. 12/676,363 and 61/251,825 are assigned to the common assignees of the present invention and are hereby incorporated in their entirety by reference. It will be appreciated that many of the methods described hereinabove may be applied in the process of Photo-Animation, as disclosed in U.S. patent application Ser. Nos. 12/676,363 and 61/251,825.

For example, the present invention may be implemented in the context of applications for automatic fitting. As described hereinabove, the present invention may provide highly accurate detection of edges and ridges. Moreover, identification of singular points and construction of the skeleton may provide additional important geometric information regarding the image objects. As disclosed in U.S. patent application Ser. No. 12/676,363, the configuration of edges and ridges may form the basic input for an automatic model fitting algorithm. Accordingly, by using the edge and ridge detection of the present invention, as well as singular points and skeleton, the performance of automatic model fitting in photo-animation may be significantly improved.

In a realistic setting, the illumination conditions, the possible similarity of the object and background colors, etc., may likely result in gaps in detected edges (ridges), regardless of the fitting method used. Therefore, when performing automatic fitting, decisions regarding whether or not a given chain of edge or ridge segments (with possible gaps between the segments) belongs to the boundary of the object to be fitted may be both difficult and significant. The present invention provides a method for making such decisions with a significantly higher probability of success. This method may be performed as follows: The segments under question may first be approximated by a smooth connected curve S. This may be accomplished essentially as described in U.S. patent application Ser. No. 12/676,363. EMEs may then be constructed along S, as described hereinabove. Next, the consistency and uniformity of the color profiles along S may be analyzed. The higher the uniformity, the higher may be the probability that the segments under question may belong to the boundary of the object to be fitted.

Another example may be in the area of automatic and automatic-interactive image completion. As disclosed in U.S. patent application Ser. Nos. 12/676,363 and 61/251,825, this may be an important operations both in improving the texture after model fitting and in completion of occluded parts of the image in image animation. The method for image completion proposed by the present invention may be especially well suited for photo-animation applications. It will be appreciated that in such applications the depth of the required completion may vary strongly, according to the size of the occluding objects, and it may typically not be known in advance. Further, interactive intervention of the user may be strongly limited, since image completion may tend to be a “professional level” operation, not suitable for the majority of photo-animation users. The completion method disclosed hereinabove may answer all these requirements, allowing for free control of the completion depth, without requiring interactive help from the user.

Another example may be in the area of automatic and automatic-interactive layers identification. As disclosed in U.S. patent application Ser. Nos. 12/676,363 and 61/251,825, the insertion of a virtual actor into a still image or into a video-sequence may be one of the more operations in photo-animation. The actor may typically be inserted in such a way that certain occlusion requirements be satisfied: some of the objects in the image (video-sequence) must be occluded by the inserted actor, while some other must occlude the actor. To satisfy this requirement the layers in the image (video-sequence) must be identified and separated according to their relative depth. As described hereinabove, the present invention may provide an efficient automatic-interactive method to achieve this goal.

Another example may be in the area of automatic animation of the background layers. As disclosed in U.S. patent application Ser. Nos. 12/676,363 and 61/251,825, the insertion and animation of a background into a virtual scene may be another important operation in photo-animation. The background may be a still image or a video-sequence. Combining automatic or automatic-interactive identification of layers and depth in the background, as described hereinabove, we can easily animate these layers.

Another example may be in the area of automatic animation of depth-uniform textures. The present invention provides a method for an automatic animation of texture areas. As explained hereinabove, the texture in images may typically be captured by using “texture models”. By applying such texture models to a certain simple motion scheme, various effects of texture motion, like the motion of waves of water or grass, may be produced.

The present invention may also have application in the area of image compression. Applications of image modelization (vectorization) to image compression are well known in the art. It is well known that by replacing pixels geometric models may provide a dramatic reduction in data volume. However, since known vectorization methods may not generally preserve a full visual quality of general high resolution images, until now, vector image compression may have been applied only in relatively restricted applications and to very special classes of images (like geographic maps).

The present invention may provide vector compression of high resolution images by providing a visually perfect reconstruction of such images, with a significant data reduction already on its basic level, marking the starting point for a vector compression to higher compression ratios.

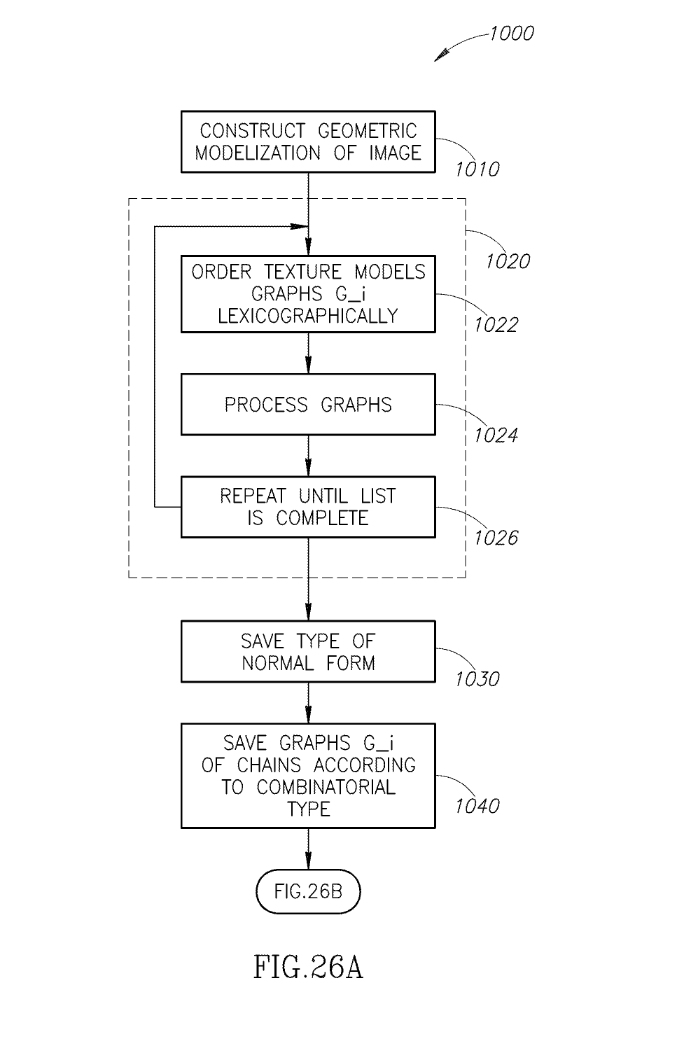

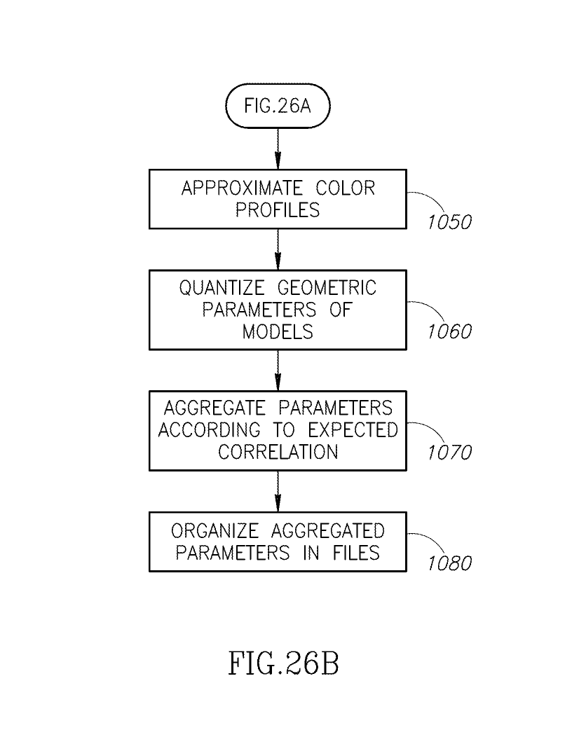

Reference is now made to FIGS. 26A and 26B which illustrates a novel compression method 1000, constructed and operative in accordance with a preferred embodiment of the present invention. A geometric modelization of the given image may be constructed (step 1010) as described hereinabove.

Each of the models may be filtered (step 1020) with quality control as will be described hereinbelow. The allowed reconstruction error may be defined as the parameter A_0. Typically, the initial value of A_0 may be ½ of a grey level. This value may generally provide a visually perfect reconstruction. Models that may have been filtered out may not participate in further steps of process 1000.

For each singular point, the type of its normal form NF in the list LNF may be saved (step 1030), together with the parameters of the normalizing transformation NT. The graphs G_j of the chains may be saved (step 1040) by their combinatorial type, by the coordinates of the vertices, and by the parameters of the spline curves representing the EME's chains, joining the vertices. Some simple types of these graphs may be organized into the lists according to relative frequencies of their appearance. In particular, for the graphs capturing letters, as in FIG. 16, f, g above, these lists may be just the standard alphabets or fonts.

The parameters of the color profiles of the EME's along the chains may be approximated (step 1050) with the prescribed accuracy A_1. Typically, the initial value of A_1 may be ½ of a grey level. This value may still provide a visually perfect reconstruction.

All the geometric parameters of the models may be quantized (step 1060) up to the accuracy A_2. Typically, the initial value of A_2 may be 1/10 of a pixel. All the brightness parameters of the models may quantized up to the accuracy A_3. Typically, the initial value of A_2 may be ½ of a grey level. These values of A_2 and A_3 may still provide a visually perfect reconstruction.

Each of the parameters of the models may be aggregated (step 1070) according to their expected correlations. In particular, only the differences of the parameters with the neighboring ones may be stored along the background areas and along chains. The same may be done with respect to the geometric parameters of geometrically adjacent or neighboring curves.

Each of the aggregated parameters of the same type may be organized (step 1080) in files which may be further compressed (in a lossless way) using known methods of statistical compression, such as, for example, Shannon coding, etc.

The compression with the initial values of parameters A_0-A_3 as described hereinabove may already provide a significant reduction of the data volume in comparison with the initial pixel representation of the image. However, if a stronger compression is required, a certain degradation of the image visual quality may be inevitable. The present invention may facilitate the control of this degradation, and may avoid some well-known problems of the known compression methods, in particular, the appearance of strong visual artifacts along sharp edges and ridges.

In general, compression may be increased by increasing the values of the thresholds A_0-A_3. In accordance with a preferred embodiment of the present invention, the allowed value of the reconstruction error A_0 may be fixed first before applying step 1020, filtering with quality control.

Filtering with quality control (step 1020) may filter out the models with a minimal visual significance, while keeping the resulting image degradation within the prescribed limits. The process may usually be applied only to the entire texture models chains graphs G_i. In accordance with a preferred embodiment of the present invention, no parts of the image skeleton may be filtered out, because of its major visual significance. Proper parts of the texture models graphs G_i may also not be filtered out in order to avoid destroying them. Only entire texture models graphs G_i may be filtered out. The filtering procedure may consist of the following sub-steps:

The texture models graphs G_i may be ordered (step 1022) lexicographically, according to their length l(G_i) and to their “height” H(G_i). The height may be defined as the maximal height of the color profiles of the EME's in the graph. In turn, the height of the color profile may be defined as the maximal difference between its color values.

The graphs G_i may be processed (step 1024) starting with the last one in the above ordering. Accordingly, the shortest graphs G_i with minimal height may be processed first. Verification of model redundancy (as described hereinabove) may be applied to G_i. A_0 may be used as the value of the parameter q in this procedure. Accordingly, the texture graph G_i may be filtered out only if the image distortion caused by this omission may not exceed A_0.

Steps 1022 and 1024 may be repeated (step 1026) according to the increasing order of the texture graphs G_i until their list may be completed.

It will be appreciated that the present invention may provide a solution to the prior art's vectorization quality problem, providing a new vectorization method which may preserve full visual quality of high-resolution real world images. This solution may be based on the introduction of EMEs, and the improvement of accuracy in edge and ridge detection. The solution may also provide relatively rigorous quality control which may serve to ensure the preservation of required quality in operations on the vector data.

It will also be appreciated that the present invention may provide a new method for capturing essential geometric content of an image (i.e. the “Skeleton” and “Model Texture”), based on detection of “singular points” and on aggregation of basic geometric models on a semi-local level. This may further serve to enhance image quality, and may be leveraged to improve for image analysis and processing.

It will further be appreciated that the present invention may provide a basis for performing the entire spectrum of image processing operations in vectorized form. Maintaining a full visual quality while processing vectorized images may facilitate the translation into “vectors” (geometric models) of any visually meaningful pixel operation. It will be appreciated that some operations become much easier in vector form. The present invention may therefore over time provide a wide variety of operations which become much more efficient, as performed not on the original pixels, but on vectors (geometric models).

It will also be appreciated that the present invention may simplify some important image processing operations in vector form to an extent that may enable their completely automatic or semi-automatic execution. Accordingly, it may advance the development of “Photo-Animation” as described in U.S. patent application Ser. Nos. 12/676,363 and 61/251,825.

Unless specifically stated otherwise, as apparent from the preceding discussions, it is appreciated that, throughout the specification, discussions utilizing terms such as “processing,” “computing,” “calculating,” “determining,” or the like, refer to the action and/or processes of a computer, computing system, or similar electronic computing device that manipulates and/or transforms data represented as physical, such as electronic, quantities within the computing system's registers and/or memories into other data similarly represented as physical quantities within the computing system's memories, registers or other such information storage, transmission or display devices.

Embodiments of the present invention may include apparatus for performing the operations herein. This apparatus may be specially constructed for the desired purposes, or it may comprise a general-purpose computer selectively activated or reconfigured by a computer program stored in the computer. Such a computer program may be stored in a computer readable storage medium, such as, but not limited to, any type of disk, including floppy disks, optical disks, magnetic-optical disks, read-only memories (ROMs), compact disc read-only memories (CD-ROMs), random access memories (RAMs), electrically programmable read-only memories (EPROMs), electrically erasable and programmable read only memories (EEPROMs), magnetic or optical cards, Flash memory, or any other type of media suitable for storing electronic instructions and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method for processing images comprising:
identifying empiric model elements (EMEs) in an original high resolution photo-realistic image, wherein each said EME comprises a straight central segment, a color profile, and a control area; and
geometrically modeling said EMEs in vectorized forms to achieve a generally full visual quality for a representation of said image.

2. The method according to claim 1 and wherein said geometrically modeling comprises approximating certain local image patterns with parametric analytic aggregates, wherein a scale for said geometrically modeling is larger than one pixel in at least one direction.

3. The method according to claim 1 and wherein said geometrically modeling also comprises constructing geometric models as aggregations of said EMEs.

4. The method according to claim 3 and wherein said aggregations are chains of said EMEs.

5. The method according to claim 3 and wherein said geometric modeling also comprises constructing a geometric model from a single isolated said EME.

6. The method according to claim 1 and also comprising:
computing an approximating said EME at any point and in any direction on said image, wherein a minimum scale for accuracy is sub-pixel in size.

7. The method according to claim 1 and wherein said color profile represents image brightness separately for at least each of the colors red, green and blue (RGB) in a scale of a few pixels in a transversal direction to said central segment.

8. The method according to claim 1 and wherein said color profile is a spline function of one variable that represents a best approximation of actual image data on said control area.

9. The method according to claim 6 and also comprising:
identifying said color profile directly from data of said image on an image segment of generally a same size and shape that said EME is assumed to represent.

10. The method according to claim 6 and also comprising:
imposing said color profile in an image processing process.

11. The method according to claim 1 and wherein said control area consists of pixels where a color cross-section of said EME determines image color in a generally reliable manner.

12. The method according to claim 1 and wherein said color profile for an edge EME consists of a center polynomial of order three and two margin polynomials of order one.

13. The method according to claim 1 and wherein said color profile for a ridge EME consists of one center polynomial and two margin polynomials, all of order two.

14. The method according to claim 1 and wherein said profile for an end EME or an isolated EME is a spline function of two variables defined in its associated said control area.

15. The method according to claim 6 and wherein said computing comprises:
choosing a profile model depending on a coordinate orthogonal to said central segment, wherein said profile model is one dimensional;
fitting said profile model to said image inside said control area;
forming a dense grid G for each edge and ridge element inside said control area within a predetermined distance from said central segment;
determining a central polynomial for said color profile as a least square fitting of grey levels on G according to a polynomial of one variable P(yy), wherein coordinate xx is defined in the edge/ridge direction, with the transversal coordinate yy, and wherein said polynomial is of degree 3 for said edge elements and degree two for said ridge elements;
adding two margin polynomials to said central polynomial to extend said color profile by two pixels, wherein each said margin polynomial adds an additional width of one pixel.

16. The method according to claim 15 and also comprising:
selecting an appropriate method for curvilinear structure detection;
employing said appropriate method to produce a collection of directed segments by detecting recognizable curvilinear structures, wherein each said directed segment generally approximates an associated said curvilinear structure with a sub-pixel accuracy; and
performing said computing.

17. The method according to claim 1 and also comprising:
detecting edge/ridge elements on different scales to provide both higher geometric resolution and robustness.

18. The method according to claim 17 and wherein said detecting comprises:
identifying possible locations of edge/ridge elements in said image, wherein areas AE approximate an expected location of an identified said edge, and areas AR approximate an expected location of an identified said ridge;
approximating polynomials for grey levels of said image, wherein for said areas AE said polynomial approximation is computed to the third degree, and for said areas AR said polynomial approximation is computed to the second degree.

19. The method according to claim 18 and wherein said detecting also comprises:
applying a least square approximation to results of said approximating polynomials.

20. The method according to claim 19 and wherein said applying is according to a Gaussian weight, wherein a least square fitting subject to said Gaussian weight effectively provides a fitting for a smaller scale.

21. The method according to claim 17 and also comprising:
calculating a linear polynomial Q(x,y), wherein said Q(x,y) equals zero; and
intersecting straight line defined by said Q(x,y) with an area where said computing is performed to provide said central segment.

22. The method according to claim 21 and wherein said calculating comprises:
for a said edge, computing a second derivative in the gradient direction for an approximating polynomial P(x,y) of degree 3; and
for a said ridge, computing eigenvalues and main curvatures and differentiating P in the direction of a larger eigenvalue for an approximating polynomial P(x,y) of degree 2.

23. The method according to claim 16 and also comprising:
bundling of segments in said collection according to their geometric proximity;
building preliminary said chains according to the proximity of said color profiles of said EMEs in said bundles;
constructing spline curves to approximate central lines of said preliminary chains; and
constructing final said chains of EMEs with their associated said central segments along said spline curves.

24. The method according to claim 16 and also comprising:
constructing said edge and ridge elements in all relevant colors and multiple scales to form a set of initially detected said EMEs;
constructing bundles of said edge and ridge elements according to geometric proximity of said elements;
building preliminary said chains according to the proximity of said color profiles of said EMEs in said bundles; and
constructing said central lines as spline curves approximating said elements of said preliminary chains.

25. The method according to claim 24 and wherein said constructing bundles is performed separately for said edge and ridge elements.

26. The method according to claim 24 and wherein said constructing bundles is performed initially for said edge and ridge elements together and later separated into separate said edge and ridge bundles according to a majority of associated said elements.

27. The method according to claim 24 and wherein said all relevant colors comprise R, G and B.

28. The method according to claim 24 and wherein said all relevant colors comprise Y, I and Q.

29. The method according to claim 24 and wherein said all relevant colors are Y in an initial stage of said constructing, wherein said color profiles are computed for detected shape curves in other color separations to provide an accurate image reconstruction.

30. The method according to claim 4 and also comprising:
identifying crossing singularities as center points of dense configurations of said chains of EMEs analyzed in a scale larger than those associated with an EME.

31. The method according to claim 30 and wherein said identifying comprises:
detecting said dense configurations of chains of EMEs;
analytically continuing spline curves of said chains of EMEs up to a distance, wherein x_i,j represents the intersection points of said continuations;
expanding collection x_i,j to include end points of said chains;
identifying a preliminary singular point “x” as a central point of (x_i,j); and
adding artificial segments to join said preliminary singular point “x” with said end points.

32. The method according to claim 30 and also comprising identifying said preliminary singular points as curvature singularities when just two said chains come together, wherein an angle between said continuations is greater than a pre-determined threshold.

33. The method according to claim 30 and also comprising: analyzing points on said EME chains where color profiles have abrupt changes to identify said preliminary singular points as color singularities, wherein said abrupt changes exceed a pre-determined threshold.

34. The method according to claim 30 and also comprising:
computing at least said EMEs and their said color profiles along said artificial segments;
identifying a normal form according to a geometric structure of said preliminary singular point “x” and the structure of EMEs in a vicinity of “x”;
transforming said preliminary singular point “x” to its said normal form;
iterating said computing, said identifying and said transforming a pre-determined number of times; and
defining said preliminary singular point “x” as a singular point according to attributes determined during said iterating.

35. The method according to claim 34 and wherein said identifying comprises identifying said normal form from a list of said normal forms, wherein said list is constructed empirically, according to requirements of a specific application.

36. The method according to claim 34 and wherein said identifying said normal form also comprises performing normalizing transformations on said singular point “x” to yield said normal form.

37. The method according to claim 30 and also comprising:
aggregating said chains of edge and ridge elements into connected graphs G_j, wherein said singular points are vertices of graph G and said element chains are edges of said graph G, wherein said graphs G_j are sub-graphs of connected components of G, such that said vertices of G_j are denoted as V_ji and said edges of G_j are denoted as E_ji; and
defining a skeleton “S” as a union of all said graphs G_j with l(G_j)>“ds”, wherein “ds” is a pre-determined threshold of pixels.

38. The method according to claim 37 and also comprising:
defining a model texture “MT” as a union of all said graphs G_j not included in said skeleton “S”.

39. The method according to claim 37 and also comprising:
capturing model texture by applying wavelets to a complement of said skeleton “S”.

40. The method according to claim 37 and wherein a value for said “ds” is between 3 and 16 pixels.

41. The method according to claim 37 and also comprising:
ordering graphs G_j according to decreasing length;
filtering said EMEs of all said G_j according to descending order of maximal length to eliminate redundant EMEs.
constructing new said chains, singularities and graphs G_j from remaining said EMEs; and
iterating said ordering, filtering and constructing without including previous graph G_s until all said redundant EMEs are eliminated.

42. The method according to claim 38 and also comprising:
for each pixel in model control area “MCA”, expanding a signal until it stops, thus covering a connected component in said image, wherein said expanding stops over SCA, and wherein skeleton control area “SCA” is defined as a union of all said control areas of said EMEs in said skeleton, texture control area “TCA” is defined as a union of all said control areas of said EMEs in said model texture, model control area “MCA” is defined as a union of TCA and SCA, and background area “BA” is defined as all said pixels in said image not in MCA;
covering said connected components by bounding rectangles; and
constructing a polynomial approximation of color data for said image for each said rectangle to approximate a background for said image.

43. The method according to claim 40 and also comprising:
reconstructing said background by reversing processing of said constructing, said covering and said expanding.

44. The method according to claim 30 and also comprising:
enabling image instruction in a form of high-level geometric modeling language (HLGML) by applying image processing operations directly on modelized images.

45. The method according to claim 44 and wherein said processing operations comprise at least one of performing interactive skeleton deformations;
morphing texture;
modifying geometric characteristics of at least one of said elements in accordance with stated thresholds; and
interactively controlling cross-section properties.

46. The method according to claim 45 and wherein said performing interactive skeleton deformations comprises:
enabling interactive prescription of a morphing operation;
applying a standard mathematical extension F of said prescribed morphing to an entire said image;
applying said F to each geometric parameter of said skeleton in turn, wherein said parameters comprise at least said chains of elements, said singularities, and widths of said color profiles; and
preserving brightness parameters of said color profiles.

47. The method according to 45 and wherein said morphing texture comprises:
enabling interactive prescription of a morphing operation;
applying a standard mathematical extension F of said prescribed morphing to an entire said image;
applying said F to each geometric parameter of said texture in turn, wherein said parameters comprise at least said chains of elements, said singularities, and widths of said color profiles;
preserving brightness parameters of said color profiles; and
returning said texture models to their original background domains.

48. The method according to claim 37 and also comprising:
enabling automatic-interactive relative depth identification.

49. The method according to claim 48 and wherein said enabling comprises:
analyzing said edges and ridges of said skeleton according to type of said singularities in said edges and ridges to identify occlusion patterns on said skeleton;
attempting to define occluded layers and order them according to relative depth via an automatic process;
when said attempting is unsuccessful, indicating said edges identified as problematic by said automatic process to a user; and
receiving input from said user regarding said problematic edges, wherein said input is at least one of a relative depth, occlusion pattern, continuation and completion of a said problematic edge.

50. The method according to claim 48 and wherein said color profile also represents information for a “depth” color.

51. The method according to claim 50 and wherein said depth information is obtained in at least one of the following ways: 3D sensing, provided as part of a general description of said image and synthetic insertion.

52. The method according to claim 50 and also comprising:
performing automatic-interactive relative depth identification to provide relative depth of different layers; and
employing “shape from shading” methods to approximate true depth for said geometric models on said image.

53. The method according to claim 37 and also comprising:
analytically continuing spline curves representing said central lines of said EME chains in image skeleton S into an occluded area up to a distance “d”, wherein “d” expressing a desired depth for completion of said occluded area;
for intersecting said continued spline curves, if the angle between said continued spline curves exceeds 90 degrees, stopping said continuing, and otherwise continuing in a bissectrice direction up to the depth d;
extending said models texture MT and the background according to a background partition by said skeleton by creating strips around a boundary between regular and occluded pixels, wherein a width of these strips is a given parameter, and said strips are created separately in each domain of a complement to said extended skeleton;
dividing each said strip into two sub-strips, wherein a first said sub-strip is located in a domain of regular (non-occluded) pixels, and a second said sub-strip is located in a domain of said occluded pixels; and
completing said texture objects by randomly copying blocks of pixels from said first sub-strip to said second sub-strip.

54. The method according to claim 53 and also comprising:
completing regions of original said occluded area by painting their pixels according to the color of neighboring pixels.

55. The method according to claim 53 and also comprising:
enabling a user to interactively mark said spline curves for said continuing.

56. The method according to claim 1 and wherein a total data volume for said representation is less than that of said image.

57. The method according to claim 1 and also comprising:
detecting edge and ridge elements; and
automatically fitting of models in an image animation application as per said detected edge and ridge elements.

58. The method according to claim 53 and also comprising:
reconstructing said occlusions to complete an image completion in a context of an image animation application.

59. The method according to claim 58 and wherein said reconstructing is one of automatic and automatic-interactive.

60. An image compression method implemented on a computing device, the method comprising:
geometrically modelizing an image;
filtering each model created in said modelizing with quality control as per an allowed reconstruction error A_0;
for each singular point, saving type of normal form (NF) in list LNF together with parameters of normalizing transformation NT;
saving chains of graphs G_j according to combinatorial type, vertices coordinates and parameters of spline curves representing each EME's chains, joining said vertices;
approximating parameters of color profiles of said EMEs along said chains with a prescribed accuracy A_1;
quantizing geometric parameters of said models up to accuracy A_2;
aggregating each of said parameters of said models according to their expected correlations; and
organizing said aggregated parameters according to type in files.

61. The method according to claim 60 and also comprising:
further compressing said files with statistical compression.

62. The method according to claim 60 and wherein:
a value for A_0 is one half of a grey level;
a value for A_1 is one half of a grey level;
a value for A_2 is one tenth of a pixel; and
a value for A_3 is one half of a grey level.
